(19) United States
(12) Patent Application Publication
(10) Pub. No.: US 2026/0066192 A1
(43) Pub. Date: Mar. 5, 2026

(54) NANOMATERIALS BASED SUPERCAPACITOR FOR LIGHT HARVESTING

(71) Applicant: King Fahd University of Petroleum and Minerals, Dhahran (SA)

(72) Inventors: Mohammed Ashraf GONDAL, Dhahran (SA); Muhamad Yudatama PERDANA, Dhahran (SA); Umair BAIG, Dhahran (SA)

(73) Assignee: King Fahd University of Petroleum and Minerals, Dhahran (SA)

(21) Appl. No.: 19/266,778

(22) Filed: Jul. 11, 2025

Related U.S. Application Data
(60) Provisional application No. 63/690,121, filed on Sep. 3, 2024.

(51) Int. Cl. H01G 9/26; H01G 9/20; H01G 11/56; H01G 11/84

(52) U.S. Cl. CPC H01G 9/26; H01G 9/2004; H01G 11/56; H01G 11/84

(57) ABSTRACT

A light harvesting supercapacitor includes a first transparent substrate, a first active layer including copper bismuth iodide (Cu₃Bi₂I₉) nanoparticles on the first transparent substrate. The light harvesting supercapacitor further includes an electrolyte layer including a gel electrolyte disposed on the first active layer, a second active layer including Cu₃Bi₂I₉ nanoparticles on the electrolyte layer, and a second transparent substrate on the second active layer. The gel electrolyte includes polyvinylpyrrolidone (PVP), an organic solvent, and an ion-forming substance.

### CROSS-REFERENCE TO RELATED APPLICATION

The present application claims benefit of priority to U.S. Provisional Application No. 63/690,121 having a filing date of Sep. 3, 2024 and which is incorporated herein by reference in its entirety.

### STATEMENT OF PRIOR DISCLOSURE BY AN INVENTOR

Aspects of the present disclosure are described in Idris K. Popoola et. al, “Inorganic perovskite photo-assisted supercapacitor for single device energy harvesting and storage applications,” Journal of Energy Storage 73 (2023) 108828 which is incorporated herein by reference in its entirety.

### STATEMENT OF ACKNOWLEDGEMENT

Support provided by the King Fahd University of Petroleum and Minerals (KFUPM), Dhahran, Saudi Arabia under Projects #DF191032 and INHE2211 and King Abdullah City for Atomic and Renewable Energy (KACARE) is gratefully acknowledged.

### BACKGROUND

### Technical Field

The present disclosure is directed towards light harvesting techniques, and more particularly relates to a light harvesting supercapacitor fabricated using a gel electrolyte layer and copper bismuth nanoparticles.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

With the advent of civilization and industrialization, global energy demand has increased multi-fold. In order to meet the ever increasing global energy demand, renewable energy resources are constantly explored. One such renewable resource is solar energy. Solar energy is widely available and easy to harness, however, solar energy faces concerns in energy storage solutions. Photovoltaic (PV) cells, capable of directly converting sunlight into electricity, hold the potential to meet global energy demands. The first crystalline silicon (c-Si) PV device was demonstrated in 1954, high manufacturing costs rendered it impractical for large-scale power generation. Since then, extensive efforts have focused on developing cost-effective materials and manufacturing processes.

In this regard, metal-halide perovskites (MHPs), an emerging class of solar materials, are transforming the solar industry with potential for high efficiency and cost reduction. In particular, MHPs may provide high photoluminescence quantum efficiency, possess high color purity, and easy color adjustment, Hence, MHPs have desirable properties as light absorbing materials. Further, MHPs manifest broad absorbance across the ultraviolet (UV) light, visible light, and near-infrared regions of the solar spectrum. MHPs have tunable properties rendering them promising for light-harvesting supercapacitors, enabling efficient energy storage and conversion in renewable solar energy. MHPs with ABX3 structures, where A represents MA⁺, Cs⁺, Ag⁺, B is I⁻, Cl⁻, or Br⁻, and X is Pb²⁺/Sn²⁺, are known for excellent electronic and ionic conduction properties. In MHPs, the A site is occupied by organic ammonium (RNH₃⁺), phosphonium (RPH₃⁺) cations, or alkali metal cations, while halide anions (Cl⁻, Br⁻, I⁻) form the perovskite structure. The ionic and opto-ionic properties allow the migration and/or diffusion of ionic species within the ABX3 crystals without deformation. However, the electronic and optoelectronic properties of MHPs have been largely explored in the fabrication of many optoelectronic devices such as solar cell, photodetector, light emitting diode (LED), photodiode, lasing source, among many others. Recent advancements have boosted the power conversion efficiency (PCE) of perovskite solar cells from 3.8% to over 25%. MHPs are gaining attention for use in optoelectronic devices like PV cells, LEDs, photodetectors, and lasers. In battery applications, MHPs may provide metal ion intercalation. Further, MHPs were used as anode electrode in Li-ion battery. The researchers suggested topotactic insertion as the mechanism by which Li⁺ intake/release proceeded within the halide perovskite host, and reported structural stability of the CH₃NH₃PbBr₃ perovskite cycling. The synthesized device achieved specific capacity of about 200 milliampere-hours per gram (mAh/g). The perovskite layers exhibited good Li⁺ intercalation-deintercalation performance, recording a diffusion coefficient of 7.34×10⁻⁸ square centimeters per second (cm²/s), a specific capacity of 377 mAh/g, with a capacity retention of 75%. Furthermore, the investigation of ionic conduction of methylammonium lead triiodide (MAPbI₃) in a symmetric electrochemical capacitor (EC) [See: S. Zhou, L Li, H. Yu, J. Chen, C. P. Wong, N. Zhao, Thin film electrochemical capacitors based on organolead triiodide perovskite Adv. Electron. Mater. 2 (2016) 1-8]. The analysis found that the ion formation and transport processes in perovskite EC devices are primarily initiated by free charge carriers as well as interfacial dependency.

By combining the light-harvesting and energy storage properties of MHPs, integrated energy harvesting and storage devices may be created. The integrated energy harvesting devices, functioning as photo-chargeable energy storage, may address the intermittent nature of solar energy and are crucial for off-grid power sources, smart devices, IoT gadgets, and other self-powered applications. Efforts have been reported in integrating separate energy harvesting device such as solar cell and electrochemical energy storage such as, super-capacitor/battery, towards achieving single energy harvesting and storage devices. However, integrated devices fabricated using improved approach suffer from bulkiness, high cost, requiring of external circuitry and laborious fabrication process. In order to address these shortcomings, photoactive electrodes are being deployed as single electrode energy harvesting and storage devices.

Accordingly, one object of the present disclosure is to provide a light harvesting supercapacitor fabricated using a gel electrolyte and copper bismuth nanoparticles, that may circumvent the drawbacks and limitations such as high cost, low efficiency, bulky construction, and economically taxing production, of materials and methods known in the art.

### SUMMARY

In an exemplary embodiment, a light harvesting supercapacitor is described. The light harvesting supercapacitor includes a first transparent substrate, a first active layer including copper bismuth iodide (Cu₃Bi₂I₉) nanoparticles disposed on the first transparent substrate. The light harvesting supercapacitor further includes an electrolyte layer including a gel electrolyte disposed on the first active layer, a second active layer including Cu₃Bi₂I₉ nanoparticles disposed on the electrolyte layer, and a second transparent substrate disposed on the second active layer. The gel electrolyte includes polyvinylpyrrolidone (PVP), an organic solvent, and an ion-forming substance.

In some embodiments, the organic solvent is acetonitrile (CH₃CN).

In some embodiments, the ion-forming substance is phosphoric acid (H₃PO₄).

In some embodiments, the gel electrolyte has a ratio of polyvinylpyrrolidone to organic solvent of 1:2.5 to 1:12.5 by weight.

In some embodiments, the gel electrolyte has a ratio of polyvinylpyrrolidone to the ion-forming substance of 2.5:1 to 1:2.5 by weight.

In some embodiments, the gel electrolyte has an ionic conductivity of 5.0×10⁻⁴ siemens per centimeter (S/cm) to 9.9×10⁻⁴ S/cm.

In some embodiments, the first transparent substrate and second transparent substrate are each fluorine-doped tin oxide (FTO) coated glass.

In some embodiments, the Cu₃Bi₂I₉ nanoparticles are present as agglomerates having a mean primary particle size of 25 nanometer (nm) to 2500 nm and a mean agglomerate size of 2 micrometer (μm) to 100 μm.

In some embodiments, the light harvesting supercapacitor having a specific capacitance of 200 millifarad per gram (mF/g) to 350 mF/g without illumination and a specific capacitance of 550 mF/g to 700 mF/g under illumination of 100 milliwatts per square centimeter (mW/cm²).

In some embodiments, an energy density of 35 milliwatt-hour per kilogram (mW·h/Kg) to 45 mW·h/Kg without illumination and an energy density of 80 mW·h/Kg to 95 mW·h/Kg under illumination of 100 mW/cm².

In some embodiments, a power density of 1 kilowatt per kilogram (kW/Kg) to 10 kW/Kg without illumination and a power density of 11 kW/Kg to 20 kW/Kg under illumination of 100 mW/cm².

In some embodiments, an equivalent series resistance of 200 ohm (Ω) to 350Ω without illumination and an equivalent series resistance of 350Ω to 525Ω under illumination of 100 mW/cm².

In some embodiments, a charge transfer resistance of 750Ω to 1250Ω without illumination and a charge transfer resistance of 50Ω to 150Ω under illumination of 100 mW/cm².

In another exemplary embodiment, a method of forming the light harvesting supercapacitor is described. The method includes preparing a first half by depositing a first solution including the first active layer on the first transparent substrate and heating to 90° C. to 130° C. The method further includes preparing a second half by depositing a second solution including the second active layer on the second transparent substrate and heating to 90° C. to 130° C. Forming the electrolyte layer by mixing the organic solvent and polyvinylpyrrolidone heating to 75° C. to 110° C., cooling to 20° C. to 40° C. to form an intermediate, adding to the intermediate the ion-forming substance, heating to 75° C. to 110° C. to form the gel electrolyte, and disposing the gel electrolyte on the first half, and sandwiching the gel electrolyte between the first half and second half.

In some embodiments, the organic solvent is acetonitrile.

In some embodiments, the ion-forming substance is phosphoric acid.

In some embodiments, the gel electrolyte has a ratio of polyvinylpyrrolidone to organic solvent of 1:2.5 to 1:12.5 by weight.

In some embodiments, the gel electrolyte has a ratio of polyvinylpyrrolidone to the ion-forming substance of 2.5:1 to 1:2.5 by weight.

In some embodiments, the method further includes forming the Cu₃Bi₂I₉ nanoparticles by mixing Bib and CuI in a polar aprotic solvent to form a precursor mixture and heating the precursor mixture to 65° C. to 125° C. for 4 h to 12 h under an inert atmosphere.

In some embodiments, the precursor mixture has a ratio of Bib and copper(I) iodide (CuI) of 1:1 to 5:1 by mole, and the polar aprotic solvent is dimethyl sulfoxide (DMSO).

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flow chart of a method of forming a light harvesting supercapacitor, according to certain embodiments.

FIG. 2A illustrates an exemplary scheme for the synthesis of polymer hydroxypropyl vinyl acetate (HPvA) gel electrolyte, according to certain embodiments.

FIG. 2B shows Fourier transform infrared (FTIR) spectra of a HPvA gel electrolyte and pure constituents of the HPvA gel electrolyte, according to certain embodiments.

FIG. 2C shows linear sweep voltammetry (LSV) curve of the HPvA gel electrolyte in the potential window between −1 V and 4 V at a scan rate of 0.1 V/s, according to certain embodiments.

FIG. 2D is a Nyquist plot of the HPvA gel electrolyte, according to certain embodiments.

FIG. 3A is a schematic illustration of a fabrication process for a Cu-perovskite photo-assisted supercapacitor, according to certain embodiments.

FIG. 3B is a scanning electron microscopy (SEM) image of the Cu-perovskite photo-assisted electrode film at a magnification of 10 micrometer (μm), according to certain embodiments.

FIG. 3C is a SEM image of the Cu-perovskite photo-assisted electrode film at a magnification of 50 μm, according to certain embodiments.

FIG. 4A shows X-ray photoelectron spectroscopy (XPS) survey spectrum of copper bismuth iodide (Cu₃Bi₂I₉), according to certain embodiments.

FIG. 4B is a XPS spectrum of Cu 2p, according to certain embodiments.

FIG. 4C is a XPS spectrum of Bi 4f, according to certain embodiments.

FIG. 4D is a XPS spectrum of I 3d, according to certain embodiments.

FIG. 5A shows cyclic voltammetry (CV) curves of the copper-perovskite photo-assisted supercapacitor at varying scan rates, according to certain embodiments.

FIG. 5B is a schematic illustration of electrochemical energy storage mechanism for Cu-perovskite photo-assisted supercapacitor, according to certain embodiments.

FIG. 5C shows specific capacitance as a function of scan rate for Cu-perovskite photo-assisted supercapacitor, according to certain embodiments.

FIG. 5D is a Nyquist plot of Cu-perovskite photo-assisted supercapacitor, the inset provides the equivalent circuit diagram, according to certain embodiments.

FIG. 6A depicts logarithmic plots of the Power's law at specific potential for Cu-perovskite photo-assisted supercapacitor, according to certain embodiments.

FIG. 6B shows a plot for current v/s voltage (i/v⁰⁰⁵ versus v^{0.5}) at 0.8 V, according to certain embodiments.

FIG. 6C shows a capacitive-controlled contribution to Cu-perovskite photo-assisted supercapacitor, at a scan rate of 0.5 volts per second (V/s), according to certain embodiments.

FIG. 6D depicts a column graph for diffusion and capacitive-controlled contribution ratios for a Cu-perovskite photo-assisted supercapacitor at varying scan rate, according to certain embodiments.

FIG. 7A is a UV-Vis absorption spectra of Cu-perovskite photo-assisted electrode, according to certain embodiments.

FIG. 7B shows cyclic voltammetry (CV) curves of the Cu-perovskite photo-assisted supercapacitor, at varying scan rate, under illumination, according to certain embodiments.

FIG. 7C shows a schematic illustration of photo-electrochemical energy storage mechanism of Cu-perovskite photo-assisted supercapacitor, according to certain embodiments.

FIG. 7D is a specific capacitance as a function of scan rate for Cu-perovskite photo-assisted supercapacitor, under illumination, according to certain embodiments.

FIG. 8A shows logarithmic plots of the Power's law at specific potential for Cu-perovskite photo-assisted supercapacitor, under illumination, according to certain embodiments.

FIG. 8B is a plot of i/v^{0.5} versus v^{0.5} at 0.8 V under illumination, according to certain embodiments.

FIG. 8C is a capacitive-controlled contribution to a Cu-perovskite photo-assisted supercapacitor, at a scan rate of 0.1 V/s, under illumination, according to certain embodiments.

FIG. 8D depicts a column graph for the diffusion-controlled and capacitive-controlled contribution ratios for a Cu-perovskite photo-assisted supercapacitor under illumination, at varying scan rates, according to certain embodiments.

FIG. 9A shows a comparison of CV curves of Cu-perovskite photo-assisted supercapacitor at varying scan rates, with and without illumination, according to certain embodiments.

FIG. 9B shows a comparison of specific capacitance as a function of scan rate for a Cu-perovskite photo-assisted supercapacitor evaluated with and without illumination, according to certain embodiments.

FIG. 9C shows a comparison of energy density as a function of scan rate for a Cu-perovskite photo-assisted supercapacitor evaluated with and without illumination, according to certain embodiments.

FIG. 9D shows a Ragone plot comparison of a Cu-perovskite photo-assisted super-capacitor evaluated with and without illumination, according to certain embodiments.

FIG. 10A is a normalized capacitance versus cycle number of 10,000 for Cu-perovskite photo-assisted supercapacitor, according to certain embodiments.

FIG. 10B is a Nyquist plot of a Cu-perovskite photo-assisted supercapacitor after 10,000 CV cycles, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “light harvesting supercapacitor” refers to a device that combines the functions of energy storage and light absorption, designed to capture and store energy from light sources while providing rapid charge and discharge capabilities typical of supercapacitors.

As used herein, the term “supercapacitor” refers to a high-capacity electrochemical energy storage device that stores energy through electrostatic charge accumulation on conductive materials, capable of delivering rapid charge and discharge cycles with high power density.

As used herein, the term “gel electrolyte” refers to a semi-solid or gel-like material that facilitates the movement of ions between the electrodes in an electrochemical device, such as a supercapacitor or battery, while maintaining mechanical stability and flexibility.

As used herein, the term “specific capacitance” refers to the capacitance of a material or device, typically expressed in units of farads per gram (F/g) or millifarads per gram (mF/g), which measures its ability to store electrical charge per unit mass. It is an important parameter in evaluating the performance of capacitive energy storage devices such as supercapacitors.

As used herein, the term “charge transfer resistance” refers to the resistance encountered by the flow of charge during the electrochemical reaction at the interface between the electrode and the electrolyte in a device, such as a supercapacitor or battery. It is a key factor influencing the efficiency and performance of energy storage devices.

As used herein, the term “equivalent series resistance” (ESR) refers to the internal resistance of a capacitor or supercapacitor, including all resistive components such as the electrolyte, electrodes, and the connections. ESR affects the power delivery and efficiency of energy storage devices, as higher ESR leads to greater energy loss and reduced performance.

As used herein, the term “power density” refers to the amount of power (usually expressed in watts) that can be delivered per unit mass or volume (e.g., watts per kilogram or watts per liter) of a supercapacitor or energy storage device. It is a key parameter that determines how quickly energy can be released from the device.

As used herein, the term “energy density” refers to the amount of energy (usually expressed in watt-hours or joules) stored per unit mass or volume (e.g., watt-hours per kilogram or joules per liter) of a supercapacitor or energy storage device. It is a key parameter that determines how much energy can be stored and available for use.

Aspects of this disclosure pertain to a light harvesting supercapacitor. The light harvesting supercapacitor includes a first transparent substrate, a first active layer comprising Cu₃Bi₂I₉ nanoparticles disposed on the first transparent substrate, an electrolyte layer comprising a gel electrolyte disposed on the first active layer.

In some embodiments, the first transparent substrate may include but is not limited to Indium tin oxide (ITO) coated glass, soda-lime glass, quartz glass, borosilicate glass, sapphire, polyethylene terephthalate (PET), polymethyl methacrylate (PMMA), polycarbonate, polyethylene naphthalate (PEN), graphene-coated glass, silver nanowire-coated substrates, transparent conductive oxide (TCO) films, aluminum-doped zinc oxide (AZO) coated glass, gallium-doped zinc oxide (GZO) films, thin-film silicon on glass, transparent acrylic sheets, cellulose-based transparent films, zinc sulfide (ZnS) substrates, magnesium fluoride (MgF₂) coated substrates, diamond-like carbon films, yttrium aluminum garnet (YAG) crystals, transparent ceramics, barium titanate thin films, lithium niobate, electrospun polymer mats, transparent polyurethane films, nanocrystalline diamond films, copper iodide thin films, cesium iodide films, and transparent sapphire films. In a preferred embodiment, the first transparent substrate is fluorine-doped tin oxide (FTO) coated glass.

The first active layer, including Cu₃Bi₂I₉ nanoparticles, disposed on the first transparent substrate. In some embodiments, the first active layer may also include lead halide perovskites, methylammonium lead iodide (MAPbI₃), formamidinium lead iodide (FAPbI₃), cesium lead bromide (CsPbBr₃), zinc oxide (ZnO) nanoparticles, titanium dioxide (TiO₂) nanoparticles, cadmium sulfide (CdS), cadmium selenide (CdSe) quantum dots, copper indium gallium selenide (CIGS), gallium arsenide (GaAs), amorphous silicon, crystalline silicon, poly(3-hexylthiophene) (P3HT), phenyl-C61-butyric acid methyl ester (PCBM), polyaniline (PANI), polypyrrole (PPy), diketopyrrolopyrrole (DPP) polymers, fullerene derivatives, non-fullerene acceptors, tin halide perovskites, nickel oxide (NiO), molybdenum disulfide (MoS₂), tungsten disulfide (WS₂), black phosphorus, antimony sulfide (Sb₂S₃), bismuth oxyiodide (BiOI), zinc tin oxide (ZTO), organic-inorganic hybrid perovskites, quantum dot heterostructures, and layered dichalcogenides.

An electrolyte layer, including a gel electrolyte, is disposed of on the first active layer. In some embodiments, the gel electrolyte, an organic solvent, and an ion-forming substance.

In some embodiments, gel electrolyte may include but is not limited to polyethylene oxide (PEO), polyacrylonitrile (PAN), polymethyl methacrylate (PMMA), polyvinyl alcohol (PVA), polyvinylidene fluoride (PVDF), sodium alginate, chitosan, carrageenan, gelatin, agarose, xanthan gum, guar gum, polystyrene sulfonate (PSS), poly(ethylene glycol) diacrylate (PEGDA), polyimides, cellulose acetate, poly(ethylene glycol) (PEG), poly(ethyleneimine) (PEI), poly(lactic acid) (PLA), poly(lactic-co-glycolic acid) (PLGA), hydroxyethyl cellulose (HEC), carboxymethyl cellulose (CMC), poly(tetrafluoroethylene) (PTFE), polyurethane, poly(2-hydroxyethyl methacrylate) (PHEMA), poly(acrylic acid) (PAA), polyetheretherketone (PEEK), sulfonated polyetherketone (SPEEK), Nafion, and block copolymers of polystyrene and polyethylene glycol. In a preferred embodiment, the gel electrolyte includes polyvinylpyrrolidone.

In some embodiments, the organic solvent may include but is not limited to methanol, ethanol, isopropanol, butanol, acetone, dimethylformamide (DMF), dimethyl sulfoxide (DMSO), tetrahydrofuran (THF), chloroform, dichloromethane, toluene, xylene, hexane, heptane, cyclohexane, ethyl acetate, methyl acetate, benzene, anisole, pyridine, nitromethane, formamide, propylene carbonate, ethylene glycol, diethyl ether, petroleum ether, trichloroethylene, butyl acetate, diisopropyl ether, and methyl isobutyl ketone (MIBK). In a preferred embodiment, the organic solvent is acetonitrile.

In some embodiments, the ion-forming substance may include but is not limited to hydrochloric acid, sulfuric acid, nitric acid, acetic acid, citric acid, formic acid, boric acid, perchloric acid, hydrofluoric acid, carbonic acid, oxalic acid, lactic acid, malic acid, succinic acid, tartaric acid, ascorbic acid, ammonium chloride, sodium sulfate, potassium nitrate, magnesium chloride, calcium carbonate, lithium bromide, aluminum sulfate, sodium acetate, ammonium sulfate, potassium phosphate, sodium citrate, ferric chloride, zinc sulfate, and ammonium oxalate. In a preferred embodiment, the ion-forming substance is phosphoric acid.

In some embodiments, the gel electrolyte has a ratio of polyvinylpyrrolidone to organic solvent ranging from 1:2.5 to 1:12.5, including 1:2.5, 1:3, 1:3.5, 1:4, 1:4.5, 1:5, 1:5.5, 1:6, 1:6.5, 1:7, 1:7.5, 1:8, 1:8.5, 1:9, 1:9.5, 1:10, 1:10.5, 1:11, 1:11.5, and 1:12.5 by weight.

In some embodiments, the gel electrolyte has a ratio of polyvinylpyrrolidone to ion-forming substance ranging from 2.5:1 to 1:2.5, including 2.5:1, 2.3:1, 2:1, 1.8:1, 1.7:1, 1.6:1, 1.5:1, 1.4:1, 1.3:1, 1.2:1, 1.1:1, 1:1, 1:1.1, 1:1.2, 1:1.3, 1:1.4, 1:1.5, 1:1.6, 1:1.7, 1:1.8, and 1:2.5 by weight.

In some embodiment, the gel electrolyte has an ionic conductivity ranging from 5.0×10⁻⁴ to 9.9×10⁻⁴ S/cm, including 5.0×10⁻⁴-5.1×10⁻⁴ S/cm, 5.1×10⁻⁴-5.2×10⁻⁴ S/cm, 5.2×10⁻⁴-5.3×10⁻⁴ S/cm, 5.3×10⁻⁴-5.4×10⁻⁴ S/cm, 5.4×10⁻⁴-5.5×10⁻⁴ S/cm, 5.5×10⁻⁴-5.6×10⁻⁴ S/cm, 5.6×10⁻⁴-5.7×10⁻⁴ S/cm, 5.7×10⁻⁴-5.8×10⁻⁴ S/cm, 5.8×10⁻⁴-5.9×10⁻⁴ S/cm, 5.9×10⁻⁴-6.0×10⁻⁴ S/cm, 6.0×10⁻⁴-6.1×10⁻⁴ S/cm, 6.1×10⁻⁴-6.2×10⁻⁴ S/cm, 6.2×10⁻⁴-6.3×10⁻⁴ S/cm, 6.3×10⁻⁴-6.4×10 4 S/cm, 6.4×10⁻⁴-6.5×10⁻⁴ S/cm, 6.5×10⁻⁴-6.6×10⁻⁴ S/cm, 6.6×10⁻⁴-6.7×10⁻⁴ S/cm, 6.7×10⁻⁴-6.8×10⁻⁴ S/cm, 6.8×10⁻⁴-6.9×10⁻⁴ S/cm. In a preferred embodiment, the gel electrolyte has an ionic conductivity of 7.6×10⁻⁴ S/cm.

A second active layer comprising Cu₃Bi₂I₉ nanoparticles disposed on the electrolyte layer, and a second transparent substrate disposed on the second active layer. In some embodiments, the Cu₃Bi₂I₉ nanoparticles in the first active layer and/or in the second active layer are present as agglomerates and have a mean primary particle size of 25 to 2500 nm and a mean agglomerate size of 2 to 100 μm.

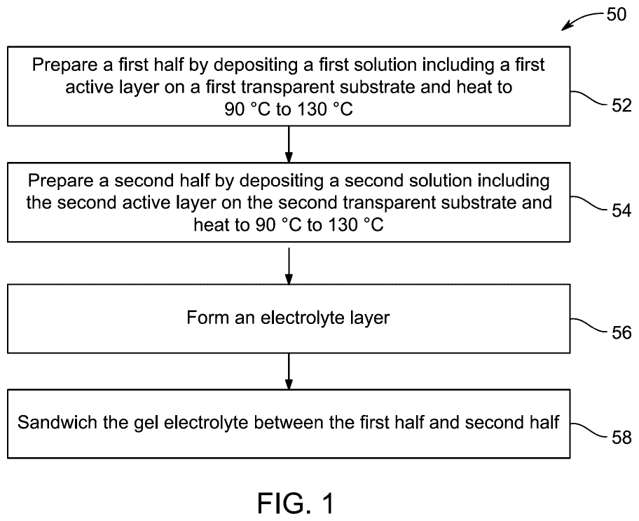

FIG. 1A illustrates a schematic flow chart of a method 50 of forming the light harvesting supercapacitor. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes preparing a first half by depositing a first solution including the first active layer on the first transparent substrate and heating to 90 to 130° C. The first active layer includes Cu₃Bi₂I₉ nanoparticles. The Cu₃Bi₂I₉ nanoparticles are prepared by mixing BiI₃ and CuI in a polar aprotic solvent to form a precursor mixture. and heating the precursor mixture to 65 to 125° C. for 4 to 12 hours under an inert atmosphere to form the Cu₃Bi₂I₉ nanoparticles.

In some embodiments, the precursor mixture has a ratio of BiI₃ to CuI ranging from 1:1 to 5:1 by mole, including specific ratios such as 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 3:1, 4:1, and 5:1 by mole. In a preferred embodiment, the precursor mixture has a ratio of BiI₃ to CuI of 3:1 by mole.

In some embodiment, the polar aprotic solvent may include but is not limited to acetonitrile, dimethylformamide (DMF), acetone, N-methyl-2-pyrrolidone (NMP), tetrahydrofuran (THF), hexamethylphosphoramide (HMPA), sulfolane, dimethylacetamide (DMAc), propylene carbonate, 7-butyrolactone, 1,3-dimethyl-2-imidazolidinone (DMI), 1,4-dioxane, ethylene carbonate, methylene chloride, chlorobenzene, toluene, anisole, acetonitrile, nitromethane, benzonitrile, dimethyl sulfoxide, 2-methyl-2-pentanone, pyridine, N-ethylpyrrolidone (NEP), 1-methyl-2-pyrrolidone (NMP), methyl ethyl ketone (MEK), dimethoxyethane, trichloromethane, and 2,2,2-trifluoroethanol. In a preferred embodiment, the polar aprotic solvent is DMSO.

In some embodiments, the first solution may be heated within a range of 90 to 130° C., including specific ranges such as 90-95° C., 96-100° C., 101-105° C., 106-110° C., 111-115° C., 116-120° C., 121-125° C., 126-130° C., 90-100° C., 100-110° C., 110-120° C., 120-130° C., 92-97° C., 98-103° C., 104-109° C., 112-117° C., 118-123° C., 124-129° C., 95-105° C., 105-115° C., more preferably about 110° C. to obtain the first half.

At step 54, the method 50 includes preparing a second half by depositing a second solution including the second active layer on the second transparent substrate and heating to 90 to 130° C., including specific ranges such as 90-95° C., 96-100° C., 101-105° C., 106-110° C., 111-115° C., 116-120° C., 121-125° C., 126-130° C., 90-100° C., 100-110° C., 110-120° C., 120-130° C., 92-97° C., 98-103° C., 104-109° C., 112-117° C., 118-123° C., 124-129° C., 95-105° C., and 105-115° C. In a preferred embodiment, the second solution is heated at 110° C.

At step 56, the method 50 includes forming the electrolyte layer. The method of forming the electrolyte layer begins with mixing and heating the organic solvent and polyvinylpyrrolidone to a temperature between 75 and 110° C., including specific ranges such as 75-80° C., 81-85° C., 86-90° C., 91-95° C., 96-100° C., 101-105° C., 106-110° C., 75-85° C., 85-95° C., 95-105° C., 100-110° C., 78-83° C., 83-88° C., 88-93° C., 93-98° C., 98-103° C., 103-108° C., 77-82° C., 82-92° C., 92-102° C., more preferably about 90° C. The mixture is further cooled to 20 to 40° C., preferably about 30° C. to form an intermediate. The intermediate is further added to the ion-forming substance, and then heated to a temperature between 75 and 110° C., including specific ranges such as 75-80° C., 81-85° C., 86-90° C., 91-95° C., 96-100° C., 101-105° C., 106-110° C., 75-85° C., 85-95° C., 95-105° C., 100-110° C., 78-83° C., 83-88° C., 88-93° C., 93-98° C., 98-103° C., 103-108° C., 77-82° C., 82-92° C., 92-102° C., more preferably about 90° C. to form the gel electrolyte. The prepared gel electrolyte is disposed of in the first half using methods known in the art.

At step 58, the method 50 includes sandwiching the gel electrolyte between the first half and second half.

In some embodiments, the specific capacitance ranges from 200 to 350 millifarad per gram (mF/g), including specific ranges such as 200-210 mF/g, 210-220 mF/g, 220-230 mF/g, 230-240 mF/g, 240-250 mF/g, 250-260 mF/g, 260-270 mF/g, 270-280 mF/g, 280-290 mF/g, 290-300 mF/g, 300-310 mF/g, 310-320 mF/g, 320-330 mF/g, 330-340 mF/g, 340-350 mF/g, 200-220 mF/g, 220-240 mF/g, 240-260 mF/g, 260-280 mF/g, and 280-300 mF/g, all measured without illumination. In a preferred embodiment, the specific capacitance is 280 mF/g without illumination.

In some embodiments, the specific capacitance ranges from 550 to 700 millifarad per gram (mF/g), including specific ranges such as 550-560 mF/g, 560-570 mF/g, 570-580 mF/g, 580-590 mF/g, 590-600 mF/g, 600-610 mF/g, 610-620 mF/g, 620-630 mF/g, 630-640 mF/g, 640-650 mF/g, 650-660 mF/g, 660-670 mF/g, 670-680 mF/g, 680-690 mF/g, 690-700 mF/g, 550-570 mF/g, 570-590 mF/g, 590-610 mF/g, 610-630 mF/g, and 630-650 mF/g, all under illumination of 100 mW/cm². In a preferred embodiment, the specific capacitance is 621 mF/g under illumination of 100 mW/cm².

In some embodiments, the energy density may range from 30 to 45 milliwatt-hour per kilogram (mW·h/Kg), including specific ranges such as 30-31 mW·h/Kg, 31-32 mW·h/Kg, 32-33 mW·h/Kg, 33-34 mW·h/Kg, 34-35 mW·h/Kg, 35-36 mW·h/Kg, 36-37 mW·h/Kg, 37-38 mW·h/Kg, 38-39 mW·h/Kg, 39-40 mW·h/Kg, 40-41 mW·h/Kg, 41-42 mW·h/Kg, 42-43 mW·h/Kg, 43-44 mW·h/Kg, 44-45 mW·h/Kg, 30-32 mW·h/Kg, 32-34 mW·h/Kg, 34-36 mW·h/Kg, 36-38 mW·h/Kg, 38-40 mW·h/Kg, all measured without illumination. In a preferred embodiment, the energy density is 38 mW·h/Kg without illumination.

In some embodiments, the energy density ranges from 80 to 95 milliwatt-hour per kilogram (mW·h/Kg), including specific ranges such as 80-81 mW·h/Kg, 81-82 mW·h/Kg, 82-83 mW·h/Kg, 83-84 mW·h/Kg, 84-85 mW·h/Kg, 85-86 mW·h/Kg, 86-87 mW·h/Kg, 87-88 mW·h/Kg, 88-89 mW·h/Kg, 89-90 mW·h/Kg, 90-91 mW·h/Kg, 91-92 mW·h/Kg, 92-93 mW·h/Kg, 93-94 mW·h/Kg, 94-95 mW·h/Kg, 80-82 mW·h/Kg, 82-84 mW·h/Kg, 84-86 mW·h/Kg, 86-88 mW·h/Kg, and 88-90 mW·h/Kg, all under illumination of 100 mW/cm². In a preferred embodiment, the energy density is 86.4 mW·h/Kg under illumination of 100 mW/cm².

In some embodiments, the power density ranges from 1 to 10 kilowatts per kilogram (kW/kg), including specific ranges such as 1-1.5 kW/kg, 1.5-2 kW/kg, 2-2.5 kW/kg, 2.5-3 kW/kg, 3-3.5 kW/kg, 3.5-4 kW/kg, 4-4.5 kW/kg, 4.5-5 kW/kg, 5-5.5 kW/kg, 5.5-6 kW/kg, 6-6.5 kW/kg, 6.5-7 kW/kg, 7-7.5 kW/kg, 7.5-8 kW/kg, 8-8.5 kW/kg, 8.5-9 kW/kg, 9-9.5 kW/kg, 9.5-10 kW/kg, 1-5 kW/kg, and 5-10 kW/kg, all without illumination. In a preferred embodiment, the power density is 5 kW/kg without illumination.

In some embodiments, the power density ranges from 11 to 20 kilowatts per kilogram (kW/kg), including specific ranges such as 11-11.5 kW/kg, 11.5-12 kW/kg, 12-12.5 kW/kg, 12.5-13 kW/kg, 13-13.5 kW/kg, 13.5-14 kW/kg, 14-14.5 kW/kg, 14.5-15 kW/kg, 15-15.5 kW/kg, 15.5-16 kW/kg, 16-16.5 kW/kg, 16.5-17 kW/kg, 17-17.5 kW/kg, 17.5-18 kW/kg, 18-18.5 kW/kg, 18.5-19 kW/kg, 19-19.5 kW/kg, 19.5-20 kW/kg, 11-15 kW/kg, and 15-20 kW/kg, all measured under illumination of 100 mW/cm². In a preferred embodiment, the power density is 16 kW/kg under illumination of 100 mW/cm².

In some embodiments, the equivalent series resistance ranges from 200 to 350Ω, including specific ranges such as 200-210 Ω, 210-220 Ω, 220-230 Ω, 230-240 Ω, 240-250 Ω, 250-260 Ω, 260-270 Ω, 270-280 Ω, 280-290 Ω, 290-300 Ω, 300-310 Ω, 310-320 Ω, 320-330 Ω, 330-340 Ω, 340-350 Ω, 200-220 Ω, 220-240 Ω, 240-260 Ω, 260-280Ω, and 280-300Ω, all without illumination. In a preferred embodiment, the equivalent series resistance is 264Ω without illumination.

In some embodiments, the equivalent series resistance ranges from 350 to 525Ω, including specific ranges such as 350-365 Ω, 365-380 Ω, 380-395 Ω, 395-410 Ω, 410-425 Ω, 425-440 Ω, 440-455 Ω, 455-470 Ω, 470-485 Ω, 485-500 Ω, 500-515 Ω, 515-525 Ω, 350-375 Ω, 375-400 Ω, 400-425 Ω, 425-450 Ω, 450-475 Ω, 475-500 Ω, 500-525Ω, and 350-400Ω, all measured under illumination of 100 mW/cm².

In some embodiments, the charge transfer resistance ranges from 750 to 1250Ω, including specific ranges such as 750-775 Ω, 775-800 Ω, 800-825 Ω, 825-850 Ω, 850-875 Ω, 875-900 Ω, 900-925 Ω, 925-950 Ω, 950-975 Ω, 975-1000 Ω, 1000-1025 Ω, 1025-1050 Ω, 1050-1075 Ω, 1075-1100 Ω, 1100-1125 Ω, 1125-1150 Ω, 1150-1175 Ω, 1175-1200 Ω, 1200-1225Ω, and 1225-1250Ω, all without illumination. In a preferred embodiment, the charge transfer resistance is 1004Ω without illumination.

In some embodiments, the charge transfer resistance ranges from 50 to 150Ω, including specific ranges such as 50-60 Ω, 60-70 Ω, 70-80 Ω, 80-90 Ω, 90-100 Ω, 100-110 Ω, 110-120 Ω, 120-130 Ω, 130-140 Ω, 140-150 Ω, 50-70 Ω, 70-90 Ω, 90-110 Ω, 110-130 Ω, 120-140 Ω, 50-80 Ω, 80-110 Ω, 100-130 Ω, 120-150Ω, and 50-100Ω, all under illumination of 100 mW/cm².

### Examples

The following examples demonstrate a light harvesting supercapacitor. The examples are provided solely for illustration and are not to be construed as limitations of the present disclosure, as many variations thereof are possible without departing from the spirit and scope of the present disclosure.

### Example 1: Materials

The chemicals pertaining to the present disclosure were obtained from Sigma Aldrich.

The chemicals included copper iodide (CuI, 99.5%), bismuth (III) iodide (Bib, 99.9%), polyvinylpyrrolidone (PVP), hydrogen phosphoric acid (H₃PO₄ᵢ, 85%), fluorine-doped tin oxide (FfO) glass with a sheet resistance of 7 Ωsq⁻¹, dimethyl sulfoxide (DMSO, 99.9% ACS reagent), acetone (99.5%) and ethanol (99.8%). All chemicals were used as received without additional processing.

### Example 2: Electrolyte Preparation

The polymer gel electrolyte, as described in the present disclosure, was synthesized at ambient conditions. In particular, 10 milliliters (mL) of acetonitrile (C₂H₃N) was taken from the stock solution into a vial. Further, 1 gram (g) of polyvinylpyrrolidone (PVP) was added to the acetonitrile in the vial. The obtained mixture was stirred at approximately 90° C. until a clear solution formed. The resulting clear solution was cooled to 30° C. Furthermore, 1 g phosphoric acid (H₃PO₄) was added to the acetonitrile-PVP solution and stirred at a constant temperature of 90° C. to produce the polymer gel electrolyte (HPvA) electrolyte.

### Example 3: Inorganic Copper Bismuth Iodide (Cu₃Bi₂I₉) Perovskite Preparation

The synthesis of Cu₃Bi₂I₉ was conducted by adding 0.5897 g of Bib and 0.5713 g of CuI (3:1) in 1 mL of DMSO solvent. Further, the mixture was stirred at 1200 revolutions per minute (rpm) for a duration of 8 hours (h), at temperature of about 90° C. Additionally, the as-synthesized Cu₃Bi₂I₉ perovskite solution was stored in nitrogen-filled glovebox for successive use.

### Example 4: Device Fabrication

The cleaning procedure for FfO glasses involved successive treatments with soapy water, deionized (DI) water, ethanol (C₂H₆O), and acetone (C₃H₆O), with each step carried out for 30 minutes (min). The cleaned FfO glasses were baked at 100° C. to remove residual organic solvents. Further, a 50 microliters (μL) volume of the as-synthesized Cu₃Bi₂I₉ solution was deposited on the FTO glass and spin-coated at 4000 rpm for 30 seconds (s). The deposited perovskite films were left to dry under ambient conditions for 5 min and subsequently heated to 110° C. for 20 min. Furthermore, the films were deployed as photo-capacitive electrodes in symmetric photo-supercapacitor devices once cooled at 30° C., with the polymer HPvA gel electrolyte sandwiched in-between the supercapacitor devices. The coupling of the photo-supercapacitor devices were secured using binder clips.

### Example 5: Material and Electrochemical Characterization

Nicolet iS50, Fourier transform infrared (FTIR) spectrophotometer, in attenuated total reflectance (ATR) mode, was utilized to evaluate the infrared spectra of the as-synthesized polymer gel electrolyte and constituent precursors at wavenumbers ranging from 4000 cm⁻¹ to 450 cm⁻¹. In addition, a plurality of analytical technique was utilized to examine the samples, such as, X-ray photoelectron spectroscopy (XPS) (ESCALAB 250Xi) for the evaluation of chemical composition, UV-vis spectrophotometer (JASCO V670) was used to record the absorption spectra of the Cu-perovskite photo-assisted electrode, and Lyra TESCAN field emission scanning electron microscopy (FESEM) for the evaluation of morphological characteristics of the photo-assisted electrode. Further, Autolab PG302N, operated with NOVA 2.1 software, was used to perform cyclic voltammetry (CV) measurements on the Cu-perovskite photo-assisted supercapacitor in a two-electrode configuration. Electrochemical impedance spectroscopy (EIS) measurements were conducted for both the HPvA gel electrolyte and the photo-assisted supercapacitor. Linear sweep voltammetry (LSV) was performed on the as-synthesized HPvA gel electrolyte at a scan rate of 0.1 V/s over a potential range between 1 V to 4 V.

The capacitance of the photo-supercapacitor was calculated using the CV plot by equation 1 given below,

$$C = \frac{{\int }_{0}^{\frac{2 {v}_{0}}{v}} \vert i \vert dt}{2 {V}_{0}} \qquad ( 1 )$$

where ‘C’ is the capacitance in Farads (F), ‘i’ is the current in amperes (A), ‘V₀’ is the maximum potential in volts (V), ‘v’ is the scan rate in volts per see (V/s), and ‘dt’ is the differential time in second (s). The specific capacitance was calculated using the equation 2, provided below,

$${C}_{s} = \frac{c}{m} \qquad ( 2 )$$

where ‘Cₛ’ is the specific capacitance in Farads per gram (F/g), ‘C’ is the capacitance (F), and ‘m’ is the mass (g) of the photo-assisted electrodes.

The energy density (E_{D}) and power density (P_{D}) of the devices were derived from equation 3 and equation 4 [See: Y. Wang, Z. Shi, Y. Huang, Y. Ma, C. Wang, M. Chen, Y. Chen, Supercapacitor devices based on graphene materials, and K. Lee, H. Lee, Y. Shin, Y. Yoon, D. Kim, H. Lee, Nano energy highly transparent and flexible supercapacitors using graphene-graphene quantum dots chelate, Materials, 2009, pp. 13103-13107, incorporated herein by reference in its entirety].

$${E}_{D} = \frac{{C ( Δ V )}^{2}}{7200 m} \qquad ( 3 )$$

$${P}_{D} = \frac{{V}_{0}^{2}}{4 ( ESR ) m} \qquad ( 4 )$$

where, ‘E_{D}’ is the energy density in watt-hours per kilogram (Wh/kg), ‘P_{D}’ is the power density (W/kg), ‘C’ is the capacitance (F), ‘AV’ is the potential window (V), ‘m’ is the mass of the photo-assisted electrodes (g), ‘V₀’ is the maximum potential (V), and ‘ESR’ is the equivalent series resistance ohms (Ω).

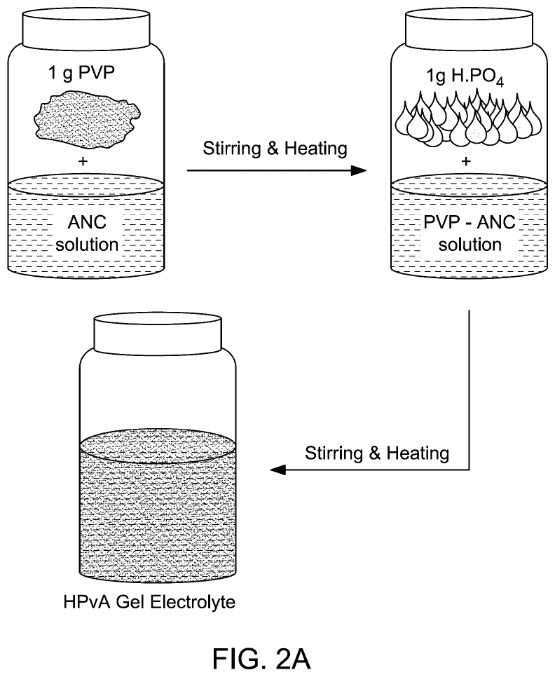

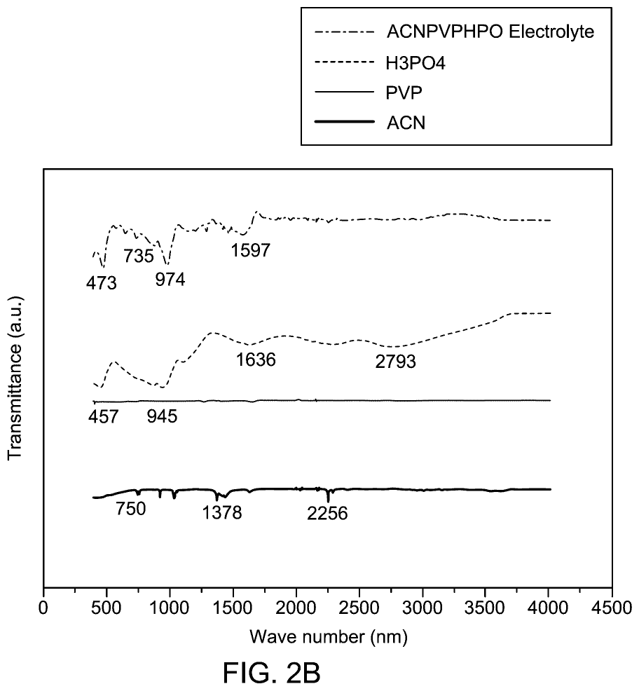

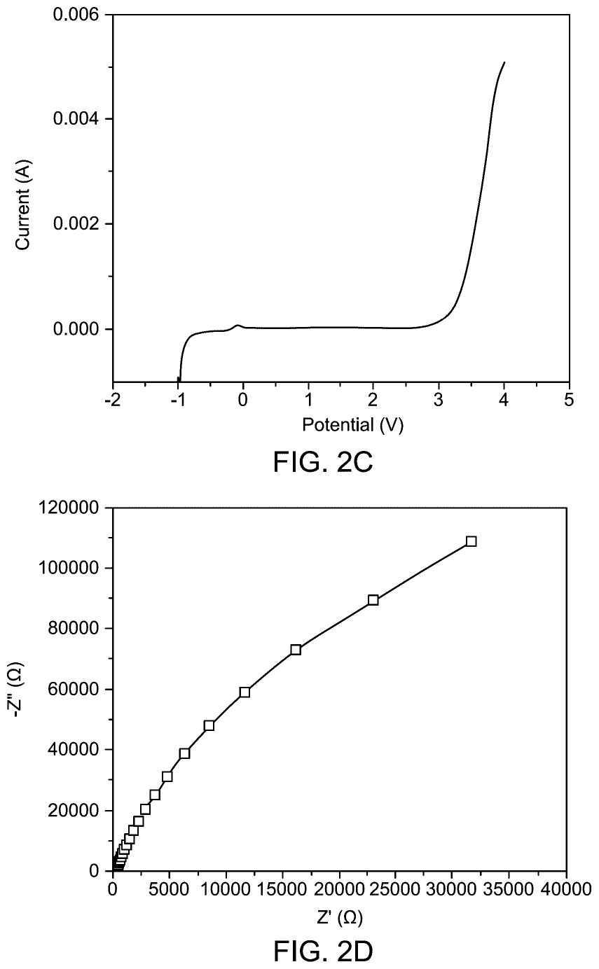

Referring to FIG. 2A, a schematic illustration of synthesis scheme for the preparation of the HPvA gel electrolyte is depicted. Further, the FTIR spectra of the HPvA gel electrolyte, acetonitrile (CH₃CN), polyvinylpyrrolidone (PVP) and phosphoric acid (H₃PO₄) is shown in FIG. 2B. The spectra peaks assignment was performed by referencing previously reported research. Furthermore, in the analysis of pristine acetonitrile, the peak at 917 cm⁻¹ is attributed to the CH₃ group. A medium CH₃ bend is observed at 1378 cm⁻¹, while the peak at 1476 cm⁻¹ corresponds to CH₃. The two peaks at 1629 cm⁻¹ and 2253 cm⁻¹ are associated to C═N and strong CN stretching mode, respectively. The FTIR spectrum of the pure PVP has stretching of C—O, at 1653 cm⁻¹. The peak at 1422 cm⁻¹ is assigned to C—H bending and the peak at 1275 cm⁻¹ is CH₂ wagging. Furthermore, for the pristine H₃PO₄, the peaks at 1122 cm⁻¹ and 2793 cm⁻¹ are attributed to P—O stretching and P—H bending modes, respectively. In the HPvA gel electrolyte spectrum, the H₃PO₄ peaks at 453 cm⁻¹ and 945 cm⁻¹ shifted to 473 cm⁻¹ and 974 cm¹, respectively. However, the H₃PO₄ peak at 1636 cm⁻¹ shifted to 1597 cm⁻¹. The H₃PO₄ peak at 2793 cm⁻¹ was observed at 2978 cm⁻¹ in the HPvA gel electrolyte spectrum. All the PVP peaks were present in the HPvA gel electrolyte. The acetonitrile peak at 750 cm⁻¹ is shifted to 735 cm⁻¹ in the HPvA gel electrolyte. The alterations in the peaks of the constituent substances of the HPvA gel electrolyte established the blending of the HPvA gel electrolyte constituents.

The electrochemical stability of the as-synthesized HPvA gel electrolyte was examined by LSV, at scan rate of 0.1 volts per second (V/s). The HPvA gel electrolyte manifests steady potential window between −1.0 V and 4.0 V, as shown in FIG. 2C. The EIS of the HPvA gel electrolyte was conducted, and the Nyquist plot was obtained from the EIS measurement, as shown in FIG. 2D. The HPvA gel electrolyte ionic conductivity (7.6×10⁻⁴ S cm⁻¹) was calculated using equation 5, as provided below,

$$σ = ( t / ( {R}_{b}^{*} S ) ) \qquad ( 5 )$$

where ‘σ’ is the ionic conductivity, ‘t’ is the thickness of the electrolyte, ‘S’ is the contact area of the electrolyte, and ‘Rb’ is the bulk resistance of the electrolyte.

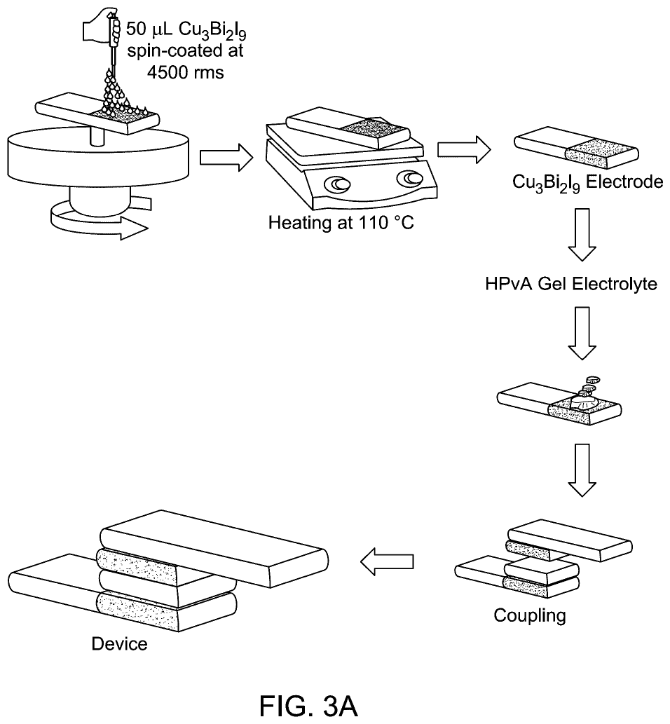

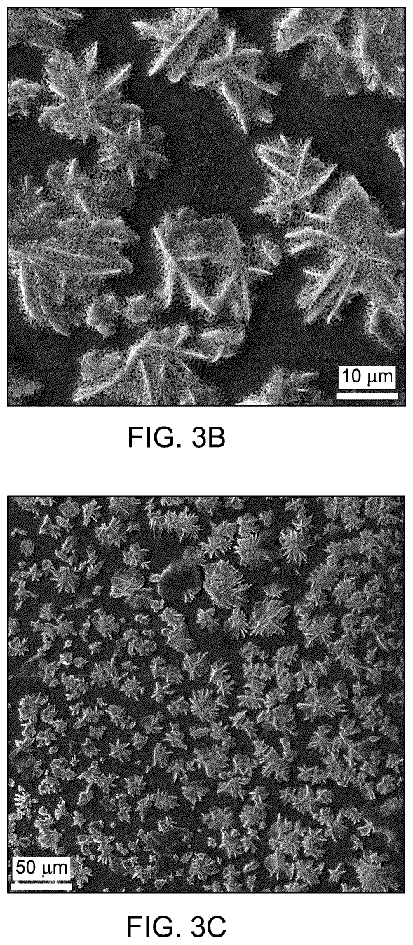

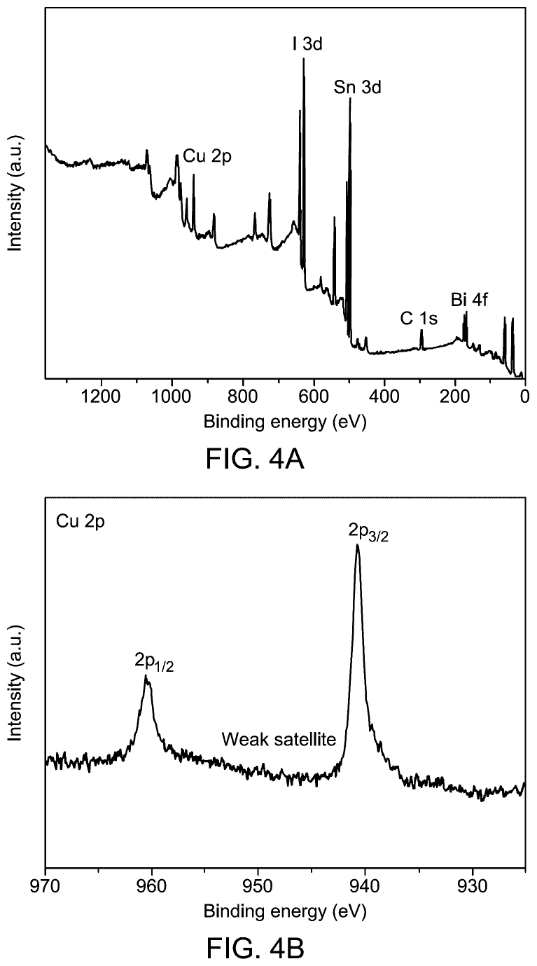

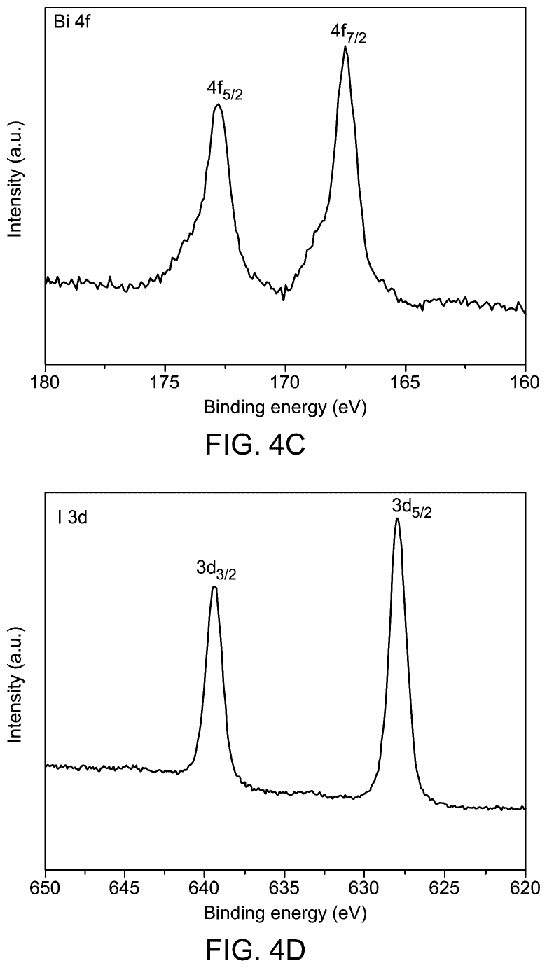

FIG. 3A illustrates a schematic illustration of a fabrication procedure for the Cu-perovskite photo-assisted supercapacitor. The morphological characteristics were evaluated by capturing the SEM image of the Cu-perovskite photoactive electrode film, as shown in FIG. 3B. The Cu-perovskite photoactive electrode film has leaf-like morphological shapes that were of varying sizes. The leaf-like morphology, characterized by distinct pores, provides a large surface area for electrode-electrolyte interaction, which is essential for efficient energy storage. The well-distributed leaf-like structures of the Cu-perovskite photoactive electrode film on the FTO current collector were observed through SEM imaging, as shown in FIG. 3C. Further, the composition of the Cu-perovskite photoactive electrode was analyzed using XPS. The XPS survey spectrum distinctly identifies the energy bands of Cu, Bi, and I, as shown in FIG. 4A. In the present disclosure, the spectrum for Cu, Bi and I. Cu 2p_{3/2} has a binding energy of 940 eV, Cu 2p_{1/2} has a binding energy of 960 eV, Bi 4f_{7/2} has a binding energy of 167.5 eV, Bi 4f_{5/2} has a binding energy of 172.8 eV, I 3d_{5/2} has a binding energy of 628 electron volt (Ev) and I 3d_{3/2} has a binding energy of 639.4 eV, as shown in FIGS. 4B-4D. The Cu-perovskite photoactive electrode, with the chemical formula copper bismuth iodide (Cu₃Bi₂I₉), is analogous to methylammonium bismuth iodide ((MA)₃Bi₂I₉).

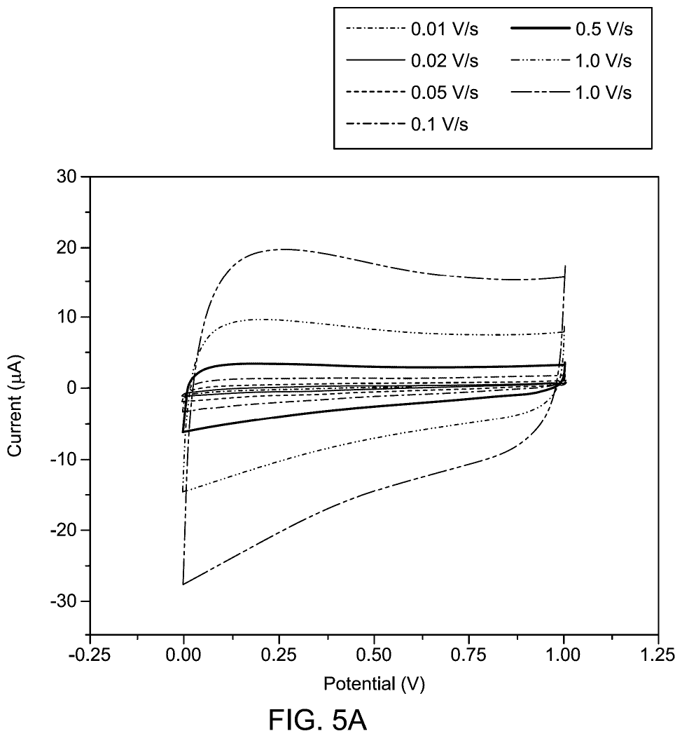

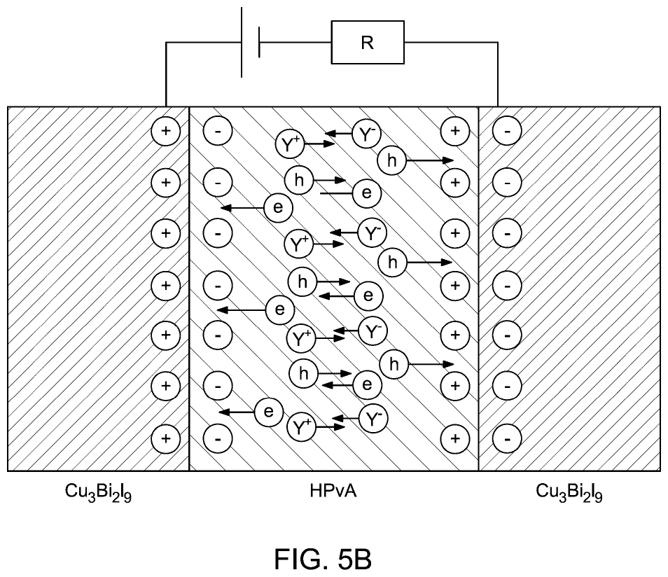

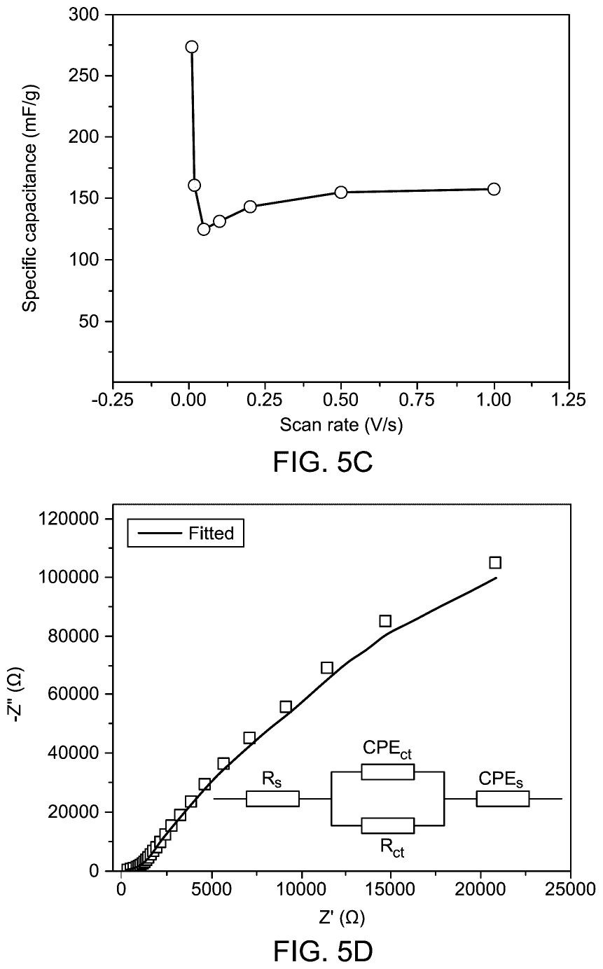

The cyclic voltammetry (CV) measurements for the Cu-perovskite photo-assisted supercapacitor were conducted at various scan rates, ranging from 0.01 V/s to 1.0 V/s, including 0.02 V/s, 0.05 V/s, 0.1 V/s, 0.2 V/s, and 0.5 V/s. The measurements were performed within a potential window of 0.0 V to 1.0 V, as shown in FIG. 5A. The obtained CV curves were having partial rectangular shapes, which indicate hybrid capacitive and diffusion energy storage processes in the Cu-perovskite photo-assisted supercapacitor. Furthermore, the CV current increases with the scan rate, while the CV curves retain their shape without noticeable deformation. The behavior highlights the dominance of the capacitive energy storage mechanism, along with the high-rate capability and excellent stability of the Cu-perovskite photo-assisted supercapacitor. A maximum CV current of about 27.7 micro ampere (μA) was reached, at a scan rate of 1.0 V/s. Further, the electrochemical energy storage mechanism of the Cu-perovskite photo-assisted supercapacitor, is shown in FIG. 5B. The relationship between specific capacitance and scan rate, is shown in FIG. 5C. At a scan rate of 0.01 V/s, peak specific capacitance of 273 mF/g was attained, while at the highest scan rate, a specific capacitance value of 158 mF/g was recorded. The interaction between the electrolyte and the electrode plays a crucial role in the electrochemical charge storage performance of supercapacitors. At lower scan rates, sufficient time is available for the Cu-perovskite photoactive electrodes to interact effectively with the HPvA gel electrolyte, resulting in enhanced energy storage capacity.

The kinetics of the charge storage process were investigated through EIS measurements, and the Nyquist plot are shown in FIG. 5D. The impedance axes of the Nyquist plot manifest mini arc at high frequency, while at low frequency, the plot exhibits no semicircle, indicating the presence of diffusion and capacitive storage mechanisms for the Cu-perovskite photo-assisted supercapacitor. The mini arc exhibited by the Nyquist plot is suggestive of the moderate charge transfer resistance offered by the supercapacitor. The inset shown in FIG. 5D is equivalent circuit diagram employed fitting the Nyquist plot. The equivalent series resistance (Rₛ), attributed to the total ionic resistance of the HPvA gel electrolyte, the internal resistance of the Cu-perovskite photoactive electrode, and the surface resistance between the photoactive electrode and the FfO current collector, was determined to be 264Ω. Further, ‘R_{CT}’ represents the charge transfer resistance, and the device exhibited an R_{CT} value of 1004Ω. CPE_{CT} is the device constant phase element representing the double layer capacitance, with a value of 3.78 mF. Constant phase element capacitance representing the dominant capacitive property (CPEs) has a value of 1 mF, as listed in Table 1 and Table 2.

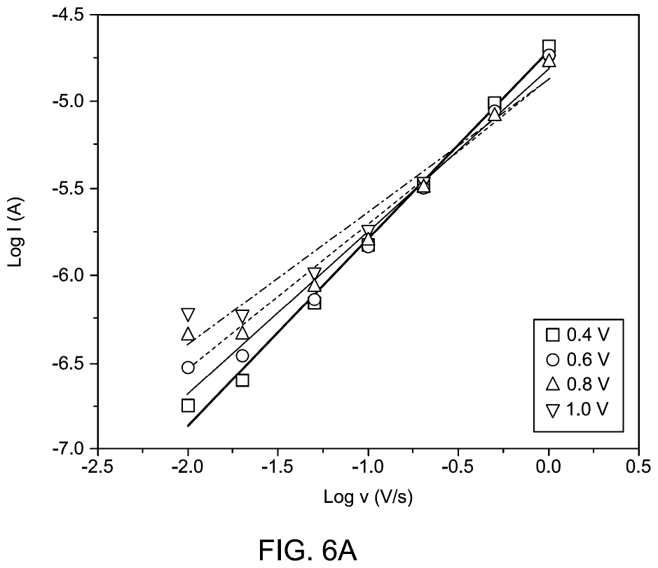

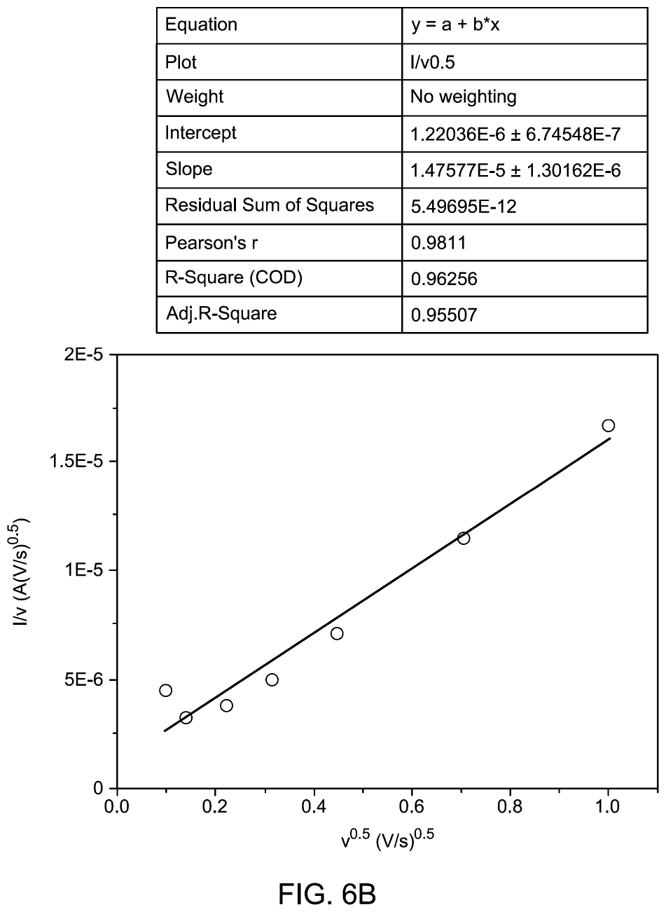

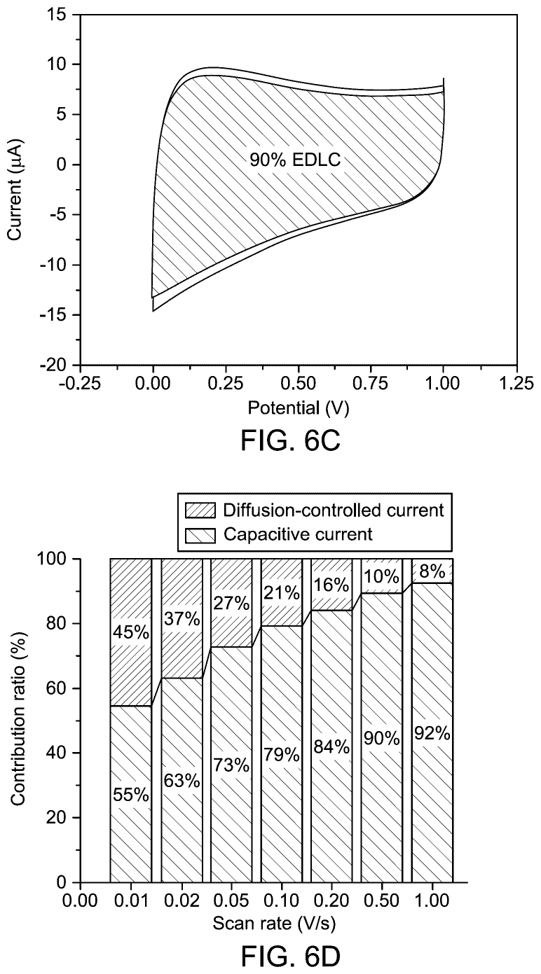

Using Power's law given in equation 6a, with the logarithm equivalence given in equation 6b, the CV current is qualitatively decoupled into the capacitive and diffusion-controlled mechanism components [See: M. S. Javed, S. S. Ahmad Shah, T. Najam, M. K. Aslam, J. Li, S. Hussain, M. A. Ahmad, M. Ashfaq, R. Raza, W. Mai, Synthesis of mesoporous defective graphene-nanosheets in a space-confined self-assembled nanoreactor: highly efficient capacitive energy storage, Electrochim. Acta 305 (2019) 517-527, incorporated herein by reference in its entirety].

$$i = {av}^{b} \qquad ( 6 a )$$

$$log i = b ( log v ) + log a \qquad ( 6 b )$$

where, ‘i’ is the current at specific potential, ‘v’ is the scan rate, ‘a’ and ‘b’ are parametric variables. The b-value, which is the slope of the plot of equation 6b, has two generally known values. A b-value of 0.5 indicates diffusion-controlled charge storage process, while a b-value of 1.0 corresponds to capacitive-controlled charge storage mechanism [See: J. Wang, J. Polleux, J. Lim, B. Dunn, Pseudocapacitive contributions to electrochemical energy storage in TiO₂ (anatase) nanoparticles, J. Phys. Chem. C. 111 (2007) 14925-14931, incorporated herein by reference in its entirety]. Any b-value between these two known values is indicative of hybrid diffusion-controlled and capacitive-controlled energy storage mechanism. The logarithmic plot of equation 6b is shown in FIG. 6A, for potential scan rates ranging from 0.4 V, 0.6 V, 0.8 V and 1.0 V. The b-values obtained are 1.0, 0.93, 0.83, and 0.76 for potentials of 0.4 V, 0.6 V, 0.8 V, and 1.0 V, respectively. The aforementioned values indicate the dominance of the capacitive-controlled charge storage mechanism across the specified potentials.

Quantification of the respective contributions from the diffusion-controlled and capacitive-controlled charge storage processes, at a specific potential, may be achieved by the Dunn's equation, given in equation 7a and equation 7b [See: J. Iqbal, A. Numan, S. Rafique, R Jafer, S. Mohamad, K. Ramesh, S. Ramesh, High performance supercapacitor incorporating ternary nanocomposite of multiwalled carbon nanotubes decorated with Co₃O₄ nanograins and silver nanoparticles as electrode material, Electrochim. Acta 278 (2018) 72-82, incorporated herein by reference in its entirety]. The Dunn's equation is scan-rate dependent.

$${i}_{D} ( V ) = {c}_{1} ( v ) + {c}_{2} ( {v}^{1 / 2} ) \qquad ( 7 a )$$

$${i}_{D} ( V ) / ( {v}^{1 / 2} ) = {c}_{1} ( {v}^{1 / 2} ) + {c}_{2} \qquad ( 7 b )$$

where, ‘c₁’ (v) and ‘c₂’ (v^{1/2}) represent the capacitive-controlled current and diffusion-controlled current, respectively. The c₁ and c₂ are obtained from the plot of equation 7b, at a potential of 0.8 V, represent the slope and intersection of the plot, respectively, as shown in FIG. 6B. The capacitive current contribution of 90% was reached by Cu-perovskite photo-assisted supercapacitor, at a scan rate of 0.5 V/s, as shown in FIG. 6C. The diffusion-current is depicted which had 10% contribution to the CV current. Furthermore FIG. 6D shows the diffusion-controlled and capacitive-controlled contribution percentages of the total CV current as a function of scan rate. The dominance of the capacitive-controlled contribution is observed across all scan rates. The capacitive current increases as the scan rate increases, while the diffusion current decreases with increasing scan rate. Hence, the rapid adsorption/desorption of the HPvA gel electrolyte ions at higher scan rate is credited with the increasing capacitive current contribution.

TABLE 1
The Nyquist curves fitting parameters of the device without
and with light obtained from the equivalent circuit.

| Mode | R_{S} (Ω) | R_{CT} (Ω) | CPE_{S} (mF) | CPE_{CT} (mF) |
|---|---|---|---|---|
| Without | 264 | 1004 | 3.78 | 1.00 |
| With light | 101 | 436 | 9.90 | 2.29 |

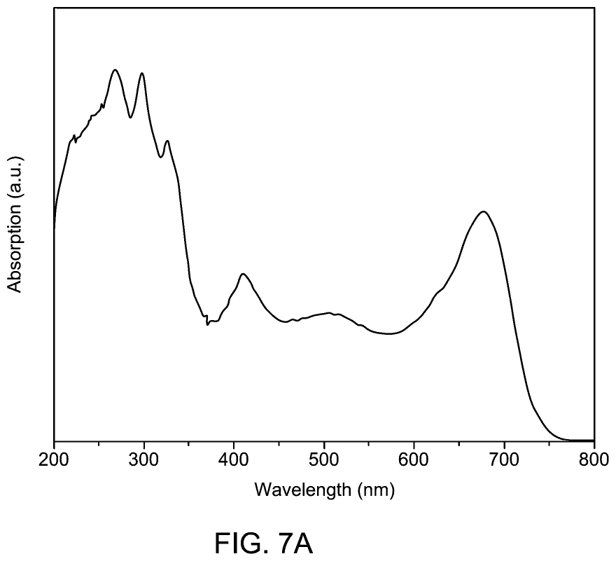

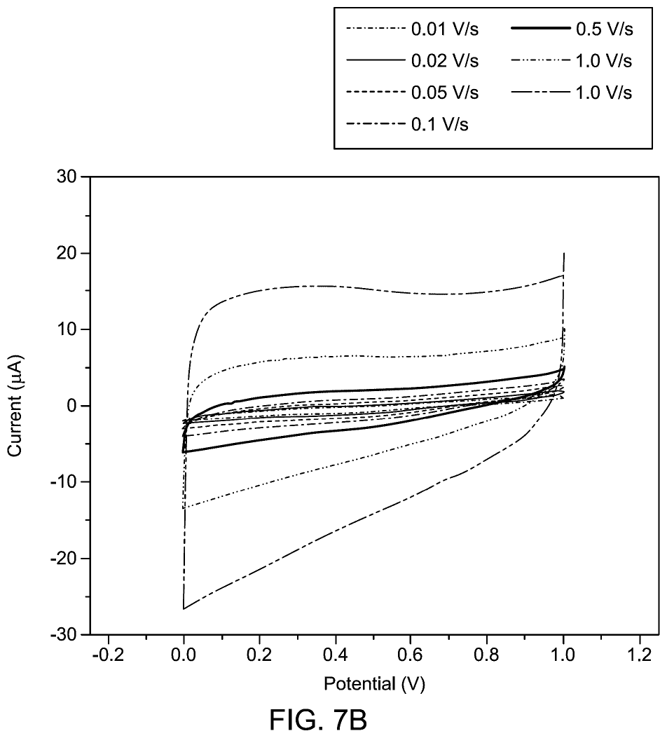

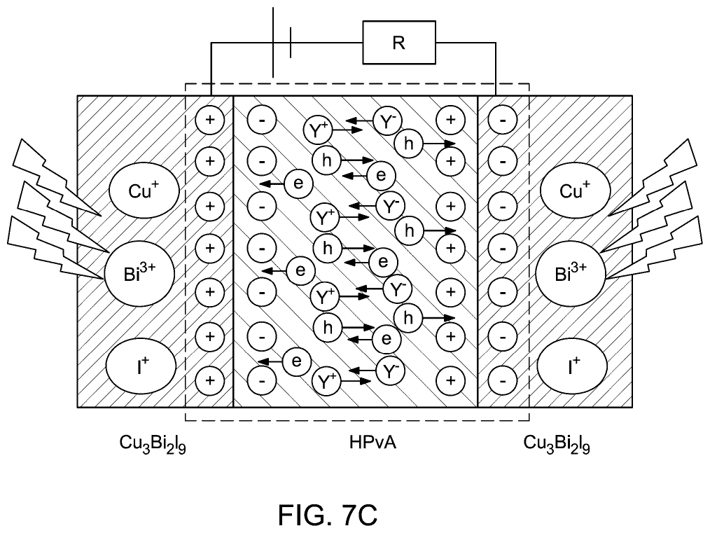

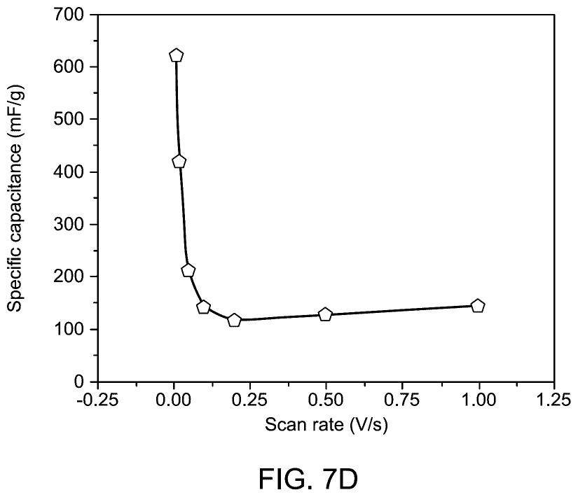

The absorbance spectrum of the Cu-perovskite photoactive electrode is shown in FIG. 7A. The electrode exhibits sharp absorption spectrum around the ultra-violet (UV) region, followed by another sharp absorption, with intensity lower than that in the UV region was observed around 400 nm. A relatively broad absorption peak is recorded around 450 nm to 550 nm. An absorption spectrum with sharp peak having intensity notable than those recorded within the visible region was evaluated at the near infrared (IR) region. Hence, the Cu-perovskite photoactive electrode is a suitable photo-harvesting material, as it may harvest light across the solar spectrum.

The photo-electrochemical storage performance of the Cu-perovskite photo-assisted supercapacitor was evaluated under illumination of Oriel lamp solar simulator with light intensity of 100 milliwatts per square centimeter (mW/cm²). The band gap of the Cu-perovskite electrode was estimated as 3.41 eV by a Tauc plot. The electrochemical evaluation focuses on the performance of the Cu-perovskite photo-assisted supercapacitor, with the photo-electrochemical CV measurement conducted under illumination, as shown in FIG. 7B. The CV curves under illumination have similar partial regular shapes as recorded by the Cu-perovskite photo-assisted supercapacitor, under non-illumination condition. Hybrid capacitive and diffusion energy storage mechanisms were present in the Cu-perovskite photo-assisted supercapacitor, under illumination. The photo-electrochemical CV current is found to increase with increment in the scan rate. A peak photo-electrochemical CV current of about 26.6 μA was attained, at a scan rate of 1.0 V/s. FIG. 7C shows the photo-electrochemical energy storage process in the Cu-perovskite photo-assisted supercapacitor, with opto-ionic generation within the Cu-perovskite photoactive electrodes. Each electrode, including the cathode and anode, generates electron-hole pairs, which are separated and migrated under the influence of the applied bias. Photo-generated electrons and holes are separated by the bias, mitigating against onset of recombination.

Thereby, leading to selective charge accumulation at the electrodes. FIG. 7D shows the plot of the specific capacitance with scan rate, under illumination. At a scan rate of 0.01 V/s, maximum specific capacitance of 621 mF/g was attained, representing 127% increment in the specific capacitance as compared with that obtained with no illumination. Hence, opto-ionic contribution leads to augmented energy storage performance of the Cu-perovskite photo-assisted supercapacitor.

TABLE 2
Performance comparison with previous research

| | | Areal/Specific | | | | | | |
|---|---|---|---|---|---|---|---|---|
| Materials | Electrolyte | Capacitance | | Energy Density | | Power Density | | Ref. |
| MAPbI₃ | 1-Butanol | 3.68 | μF cm⁻² | | | | | 1* |
| | MAI/1-Butanol | 5.89 | μF cm⁻² | | | | | |
| MABi₃I₉ | MAI/Butanol | 5.5 | mF cm⁻² | | | | | 2* |
| MAPbI₃ | | 523 | mF cm⁻² | 57 | Wh/Kg | | | 3* |
| MAPbI₃ | CHLPVAKOH | 8.32 | μF cm⁻² | 1.67 | nWh cm² | 5045 | mW cm⁻² | 4* |
| | CHLPVAKOHMAI | 21.5 | μF cm⁻² | 4.3 | nWh cm⁻² | 1.81 | mW cm⁻² | |
| MAPbI₃ | CHLPVAKOH | 8.06 | μF cm⁻² | 1.66 | nWh cm⁻² | 5.19 | mW cm⁻² | |
| | CHLPVAKOHMAI | 6.15 | μF cm⁻² | 1.23 | nWh cm⁻² | 0.26 | mW cm² | 4* |
| MAPbBr₃ | Tetrabutylammonium | 81.5 | mF cm⁻² | 12.75 | mWh Kg⁻¹ | 225 | W Kg⁻¹ | 5* |
| | tetrafluoroborate | | | | | | | |
| | in dichloromethane | | | | | | | |
| MAPbBr₃ | Tetrabutylammonium | 39.8 | μF cm⁻² | 24.02 | mWh Kg⁻¹ | | | 5* |
| | tetrafluoroborate | | | | | | | |
| | in dichloromethane | | | | | | | |
| MA₃Bi₂I₉ | CPH-G gel | 0.28 | mF cm⁻² | 0.04 | μWh cm² | 5.6 | mW/cm² | 6* |
| Cu₃SbI₆ | HAAP gel | 12.9 | mF/cm² | 1.78 | μWh/cm2 | 2.10 | mW/cm² | 7* |

| | | | |
|---|---|---|---|
| 71.9 mF/cm² | 9.98 μWh/cm2 | 3.18 | mW/cm² |
| (under | (under | | |
| illumination) | illumination) | | |

| | | | | |
|---|---|---|---|---|
| CsPbI₃ | CsI/Butanol | 7.23 | mF cm² | 8* |

| | | | | | |
|---|---|---|---|---|---|
| Cu₃Bi₂I₉ | HPvA gel | 273 mF/g | 38.0 mWh/kg | 5 kWKg | Present |
| | | 621 mF/g | 86.4 mWh/kg | 15 kWKg | disclosure |
| | | (under | (under | (under | |
| | | illumination) | illumination) | illumination) | |

1* S. Zhou, L. Li, H. Yu, J. Chen, C. P. Wong, N. Zhao, Thin film electrochemical capacitors based on organolead triiodide perovskite, Adv. Electron. Mater. 2 (2016) 1-8, incorporated herein by reference in its entirety.
2* J. K. Pious, M. L. Lekshmi, C. Muthu, R. B. Rakhi, V. C. Nair, Zero-Dimensional Methylanunonium Bismuth Iodide-Based Lead-Free Perovskite Capacitor, 2017, pp. 5798-5802, incorporated herein by reference in its entirety.
3* A. Slonopas, H. Ryan, P. Norris, Ultrahigh energy density CH₃NH₃PbI₃ perovskite-based supercapacitor with fast discharge, Electrochim. Acta 307 (2019) 334-340, incorporated herein by reference in its entirety.
4* I. Popoola, M. Gondal, L. Oloore, A. J. Popoola, J. AlGhamdi, Fabrication of organometallic halide perovskite electrochemical supercapacitors utilizing quasi-solid-state electrolytes for energy storage devicesElectrochim. Acta 332 (2020), 135536, incorporated herein by reference in its entirety.
5* R. Kumar, P. S. Shulda, G. D. Varma, M. Bag, Synthesis of porous electrode from CH₃NH₃PbBr₃ single crystal for efficient supercapacitor application: Role of morphology on the charge storage and stability, Electrochim. Acta 398 (2021), 139344, incorporated herein by reference in its entirety.
6* Idris K. Popoola, Mohammed A. Gondal, Abdul Jelili Popoola, Luqman E. Oloore, Bismuth-based organometallic-halide perovskite photo-supercapacitor utilizing novel polymer gel electrolyte for hybrid energy harvesting and storage applications, J. Energy Storage 53 (2022) 105167, incorporated herein by reference in its entirety.
7* L K. Popoola, M. A. Gondal, L. E. Oloore, A. Popoola, Materials science & engineering, Inorganic antimony-based rudorffite photo-responsive electrochemical capacitor utilizing non-aqueous polyvinylpyrrolidone polymer gel electrolyte for hybrid energy harvesting and storage applicationsMater. Sci. Eng. B 291 (2023), 116373, incorporated herein by reference in its entirety.
8* P. Maji, A. Ray, P. Sadhukhan, A. Roy, S. Das, Fabrication of symmetric supercapacitor using cesium lead iodide (CsPbI₃) microwire, Mater. Lett. 227 (2018) 268-271, incorporated herein by reference in its entirety.

The kinetics of the photo-electrochemical charge storage mechanism was evaluated by EIS measurement, i.e., through a Nyquist plot obtained for the Cu-perovskite photo-assisted supercapacitor, under illumination. In particular, the Nyquist plot reveals an arc along the real and imaginary impedance axes at high frequencies, while moderate non-linear behavior is observed at low frequencies. The non-linear characteristic at high frequencies indicates the dominance of diffusion-controlled charge storage mechanisms in the Cu-perovskite photo-assisted supercapacitor. Under illumination, the fitted parameters obtained were, Rs=101Ω, R_{CT}=436Ω, CPE_{CT}=9.90 mF, and CPEs=2.29 mF.

The real and imaginary impedance axes of the Nyquist plot exhibit an arc at high frequency, while at low frequency, the plot manifests moderate non-linear behavior. The non-linear characteristic of the Nyquist curve at high frequency was suggestive of the prominence of diffusion-controlled charge storage mechanisms for the Cu-perovskite photo-assisted supercapacitor. The fitted parameters under illumination, the fitted parameters obtained are: Rs=101Ω, R_{CT}=436Ω, CPE_{CT}=9.90 mF, and CPEs=2.29 mF.

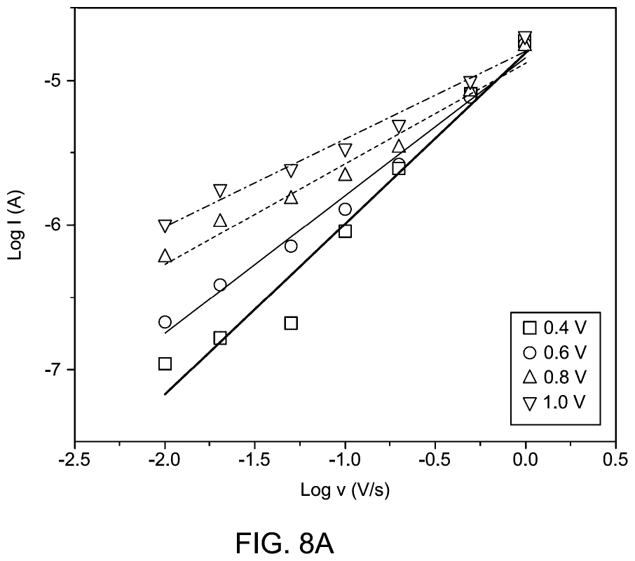

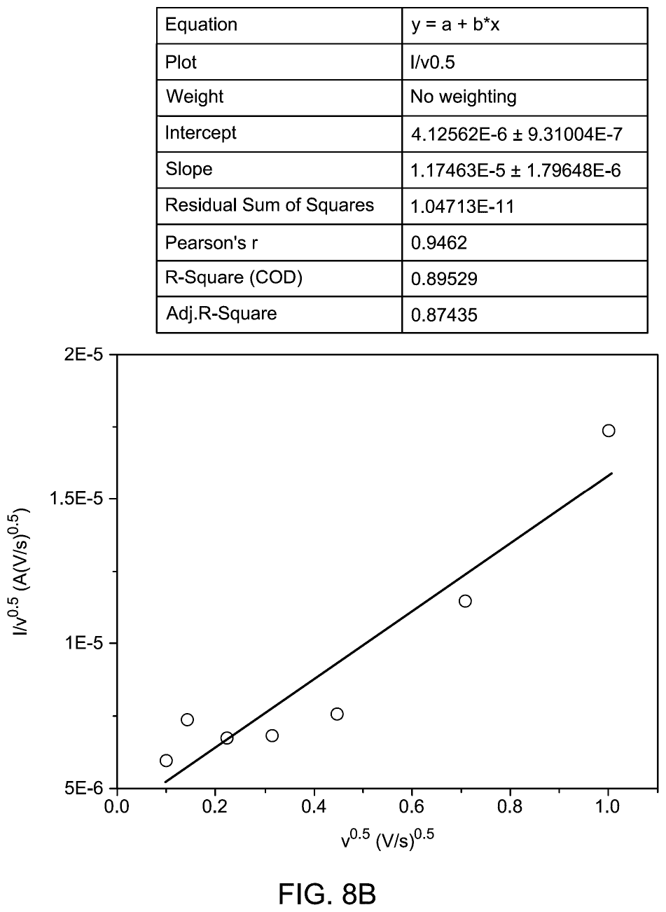

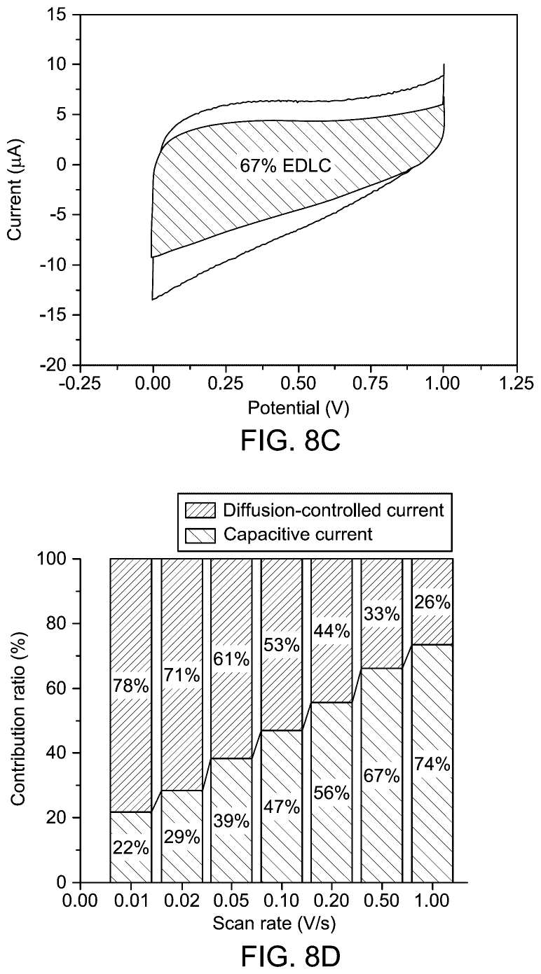

Further, the Power's law was applied again to decouple the diffusion-controlled and capacitive-controlled contributions effectively. The logarithmic plot of equation 6b for potentials of 0.4 V, 0.6 V, 0.8 V, and 1.0 V under illumination, is shown in FIG. 8A. The obtained b-values, under illumination were, 1.0, 0.94, 0.69, and 0.61 for potentials of 0.4 V, 0.6 V, 0.8 V, and 1.0 V, respectively. The b-values of 0.69 and 0.61 at potentials of 0.8 V and 1.0 V, respectively, indicate the dominance of a diffusion-controlled charge storage mechanism, attributed to the opto-ionic contribution to the photo-electrochemical cyclic voltammetry (CV) current. Furthermore, Dunn's equation used to measure the diffusion-controlled and capacitive-controlled charge storage contributions to the photo-electrochemical CV current, at a specific potential, under illumination. The plot of i/v^{0.5} versus v^{0.5} scan rate, is shown in FIG. 8B. The capacitive current contribution of the Cu-perovskite photo-assisted supercapacitor was reduced to 67%, at a scan rate of 0.5 V/s, as shown in FIG. 8C. The diffusion current contribution was found to increase to about 33% for area under illumination, confirming the opto-ionic contribution from the Cu-perovskite photoactive electrodes. The diffusion-controlled and capacitive-controlled contribution ratios to the total photo-electrochemical CV current as a function of scan rate are shown in FIG. 8D. The diffusion-controlled contributions are found to increase across all scan rates. The dominance of the diffusion-controlled contribution was observed at the scan rates of 0.01 V/s, 0.02 V/s, 0.05 V/s and 0.1 V/s. The diffusion-controlled contribution was found to decline with increasing scan rate.

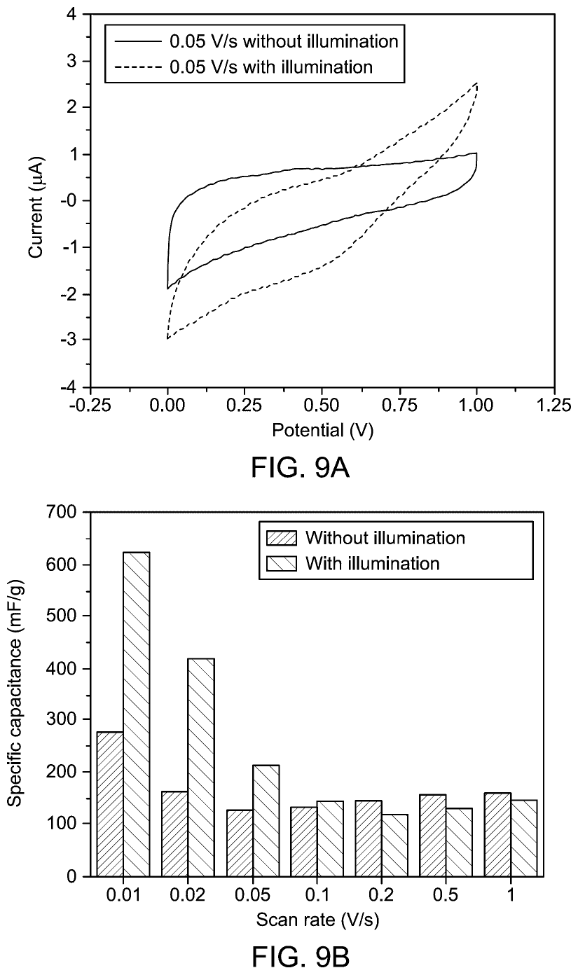

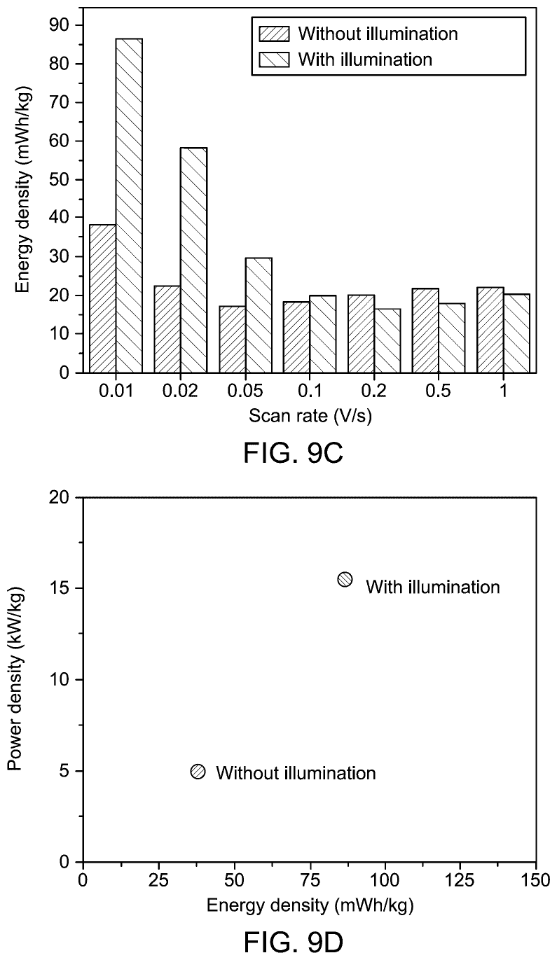

Further, the electrochemical and photo-electrochemical energy storage performance of the Cu-perovskite photo-assisted supercapacitor are compared. The cyclic voltammetry (CV) curves of the Cu-perovskite photo-assisted supercapacitor were recorded at a scan rate of about 0.05 V/s, under illuminated and non-illuminated conditions. The curve without illumination was observed to have a partially rectangular shape, while the curve under illumination was noted to deviate significantly from rectangularity, indicating distinct electrochemical behaviors influenced by light exposure, as shown in FIG. 9A. The maximum CV current of about 1.88 μA and highest photo-electrochemical CV current of about 2.92 μA were reached by the Cu-perovskite photo-assisted super-capacitor. The plot of the comparison of the specific capacitance as a function of scan rate, with and without illumination is shown in FIG. 9B and the specific energy density comparison is shown in FIG. 9C. The Cu-perovskite photo-assisted supercapacitor attained maximum energy densities of about 86.4 mWh/kg and about 38.0 mWh/kg, with and without illumination, respectively, at a scan rate of 0.01 V/s. About 127% of energy density augmentation was recorded at the scan rate of 0.01 V/s. Ragone plot of the Cu-perovskite photo-assisted supercapacitor, with and without illumination is shown in FIG. 9D.

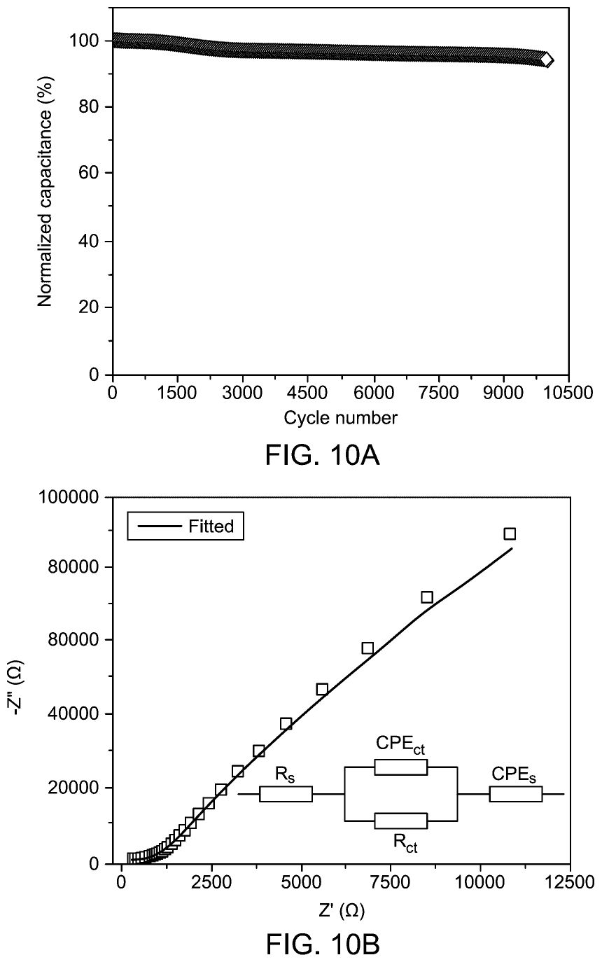

FIG. 10A shows the normalized capacitance for the cyclic charge-discharge of the Cu-perovskite photo-assisted supercapacitor. The cyclic charge-discharge was conducted for 10,000 cycle numbers. The Cu-perovskite photo-assisted supercapacitor retained 93.8% of the original capacitance, after 10,000 charge-discharge cycles. The EIS measurement after 10,000 charge-discharge cycles was performed, and the Nyquist plot obtained is depicted in FIG. 10B. A ‘R_{S}’ value of 315.52Ω was derived from the Nyquist plot. The Nyquist plot has similar characteristic as shown in FIG. 5D before 10,000 charge-discharge cycles. Hence, the Cu-perovskite photo-assisted supercapacitor exhibited high cyclic charge-discharge stability. The device recorded 100% coulombic efficiency after undergoing charge-discharge cycles.

The aspects of the present disclosure provide the method of fabricating the Cu-perovskite photo-assisted super-capacitor serving the dual functionalities of energy harvesting and electrochemical energy storage in a single device. The Cu-perovskite photo-assisted supercapacitor included the HPvA gel electrolyte. The electrochemical and photo-electrochemical energy storage performance of the Cu-perovskite photo-assisted supercapacitor were evaluated. The device achieved 127% energy density augmentation, at a scan rate of 0.01 V/s. The Cu-perovskite photo-assisted supercapacitor retained 93.8% of the initial capacitance, after 10,000 charge-discharge cycles.

Numerous modifications and variations of the present disclosure are possible in light of the above teachings. It is, therefore, to be understood that within the scope of the appended claims, the invention may be practiced otherwise than as specifically described herein.

1. A light harvesting supercapacitor, comprising:
a first transparent substrate;
a first active layer comprising Cu₃Bi₂I₉ nanoparticles disposed on the first transparent substrate;
an electrolyte layer comprising a gel electrolyte disposed on the first active layer;
a second active layer comprising Cu₃Bi₂I₉ nanoparticles disposed on the electrolyte layer; and
a second transparent substrate disposed on the second active layer,
wherein the gel electrolyte comprises polyvinylpyrrolidone, an organic solvent, and an ion-forming substance.

2. The light harvesting supercapacitor of claim 1, wherein the organic solvent is acetonitrile.

3. The light harvesting supercapacitor of claim 1, wherein the ion-forming substance is phosphoric acid.

4. The light harvesting supercapacitor of claim 1, wherein the gel electrolyte has a ratio of polyvinyl pyrrolidone to organic solvent of 1:2.5 to 1:12.5 by weight.

5. The light harvesting supercapacitor of claim 1, wherein the gel electrolyte has a ratio of polyvinyl pyrrolidone to the ion-forming substance of 2.5:1 to 1:2.5 by weight.

6. The light harvesting supercapacitor of claim 1, wherein the gel electrolyte has an ionic conductivity of 5.0×10-4 to 9.9×10-4 S/cm.

7. The light harvesting supercapacitor of claim 1, wherein the first transparent substrate and second transparent substrate are each fluorine-doped tin oxide (FTO) coated glass.

8. The light harvesting supercapacitor of claim 1, wherein the Cu₃Bi₂I₉ nanoparticles are present as agglomerates having a mean primary particle size of 25 to 2500 nm and a mean agglomerate size of 2 to 100 μm.

9. The light harvesting supercapacitor of claim 1, having a specific capacitance of 200 to 350 milifarad per gram (mF/g) without illumination and a specific capacitance of 550 to 700 milifarad per gram (mF/g) under illumination of 100 mW/cm².

10. The light harvesting supercapacitor of claim 1, having an energy density of 30 to 45 miliwatt-hour per kilogram (mW·h/Kg) without illumination and an energy density of 80 to 95 miliwatt-hour per kilogram (mW·h/Kg) under illumination of 100 mW/cm².

11. The light harvesting supercapacitor of claim 1, having a power density of 1 to 10 kilowatt per kilogram (kW/Kg) without illumination and a power density of 11 to 20 kilowatt per kilogram (kW/Kg) under illumination of 100 mW/cm².

12. The light harvesting supercapacitor of claim 1, having an equivalent series resistance of 200 to 350Ω without illumination and an equivalent series resistance of 350 to 525 under illumination of 100 mW/cm².

13. The light harvesting supercapacitor of claim 1, having a charge transfer resistance of 750 to 1250Ω without illumination and a charge transfer resistance of 50 to 150 under illumination of 100 mW/cm².

14. A method of forming the light harvesting supercapacitor of claim 1, comprising:
preparing a first half by depositing a first solution comprising the first active layer on the first transparent substrate and heating to 90 to 130° C.;
preparing a second half by depositing a second solution comprising the second active layer on the second transparent substrate and heating to 90 to 130° C.;
forming the electrolyte layer by
mixing the organic solvent and polyvinylpyrrolidone
heating to 75 to 110° C.,
cooling to 20 to 40° C. to form an intermediate,
adding to the intermediate the ion-forming substance,
heating to heating to 75 to 110° C. to form the gel electrolyte, and
disposing the gel electrolyte on the first half; and
sandwiching the gel electrolyte between the first half and second half.

15. The method of claim 14, wherein the organic solvent is acetonitrile.

16. The method of claim 14, wherein the ion-forming substance is phosphoric acid.

17. The method of claim 14, wherein the gel electrolyte has a ratio of polyvinyl pyrrolidone to organic solvent of 1:2.5 to 1:12.5 by weight.

18. The method of claim 14, wherein the gel electrolyte has a ratio of polyvinyl pyrrolidone to the ion-forming substance of 2.5:1 to 1:2.5 by weight.

19. The method of claim 14, further comprising:
forming the Cu₃Bi₂I₉ nanoparticles by
mixing Bib and CuI in a polar aprotic solvent to form a precursor mixture, and
heating the precursor mixture to 65 to 125° C. for 4 to 12 hours under an inert atmosphere.

20. The method of claim 19, wherein the precursor mixture has a ratio of Bib and CuI of 1:1 to 5:1 by mole; and the polar aprotic solvent is DMSO.
